(19) United States
(12) Patent Application Publication
(10) Pub. No.: US 2009/0297017 A1
(43) Pub. Date: Dec. 3, 2009

(54) HIGH RESOLUTION MULTIMODAL IMAGING FOR NON-DESTRUCTIVE EVALUATION OF POLYSILICON SOLAR CELLS

(76) Inventors: Janice A. Hudgings, South Hadley, MA (US); Rajeev Ram, Arlington, MA (US); Kevin McCarthy, S. Hadley, MA (US)

Correspondence Address: Mark J. Pandiscio;Pandiscio & Pandiscio, P.C., 470 Totten Pond Road, Waltham, MA, 02451-1914, US

(21) Appl. No.: 12/411,187

(22) Filed: Mar. 25, 2009

Related U.S. Application Data
(60) Provisional application No. 61/070,673, filed on Mar. 25, 2008.

(51) Int. Cl. G06K 9/00

(52) U.S. Cl. 382/141; 348/311

(57) ABSTRACT

A non-destructive evaluation system for evaluating an article such as a test sample, the system comprising:
a silicon-based CCD camera for obtaining a series of images of the article;
first apparatus for receiving the series of images of the article from the silicon-based CCD camera and using a first imaging modality to generate a first data set spatially correlated to the article;
second apparatus for receiving the series of images of the article from the silicon-based CCD camera and using a second imaging modality to generate a second data set spatially correlated to the article; and
processing apparatus for processing at least one of the first and second data sets so as to evaluate at least one physical characteristic of the article.

### REFERENCE TO PENDING PRIOR PATENT APPLICATION

This patent application claims benefit of pending prior U.S. Provisional Patent Application Ser. No. 61/070,673, filed Mar. 25, 2008 by Janice A. Hudgings et al. for THERMOREFLECTANCE FOR DEFECT MAPPING AND PROCESS-CONTROL OF SOLAR CELLS (Attorney's Docket No. ALENAS-2 PROV), which patent application is hereby incorporated herein by reference.

### GLOSSARY

As used herein, the following terms are intended to have the following meanings:

“Non-Destructive Evaluation (NDE)” and/or “Non-Destructive Inspection (NDI)” are intended to mean the evaluation and/or inspection of an article (i.e., a test sample) without damaging or significantly affecting the integrity and function of the article.

“Stochastic Resonance Enhanced (SRE) Imaging” is intended to mean the advanced form of lock-in image processing which achieves very high sensitivities by injecting optimal levels of noise into periodically excited non-linear systems.

“Thermoreflectance (TR)” is intended to mean the technique of measuring spatial temperature gradients by detecting very small changes in surface reflectance at visible wavelengths, as opposed to detecting infrared emissions as in conventional thermography.

“Stochastic Resonance Enhanced Thermoreflectance (SRETR)” is intended to mean the application of stochastic resonance enhanced (SRE) imaging so as to make small thermoreflectance (TR) signals detectable and visible as two-dimensional (2D) thermal images.

“Electroluminescence (EL)” is intended to mean the physical phenomenon in which passing currents through semiconductors results in the emission of light.

“Photoluminescence (PL)” is intended to mean the physical phenomenon in which light incident on (or through) semiconductors results in the emission of light of a second wavelength.

“Micro-photoconductivity (μ-PC)” is intended to mean the measurement of the conductivity of a solar cell when light is incident on the solar cell (it is frequently used as a silicon solar cell characterization technique to measure the conversion efficiency of the solar cell).

### FIELD OF THE INVENTION

This invention relates to methods and apparatus for locating and mapping defects, inhomogeneities and/or shunts in photovoltaic silicon solar cells, and more particularly to the use of thermoreflectance and/or other imaging modalities in connection with the same.

### BACKGROUND OF THE INVENTION

The solar cell industry has struggled to find imaging modalities which can locate defects in a solar cell with precision. The $25 billion worldwide silicon solar cell industry is growing at approximately 60% annually, and solar cells are rapidly becoming a commodity business based on volume manufacturing techniques. Solar cells are sold on the basis of delivery, price and energy efficiency, generally in that order. About 90% of the world solar cell market is for polysilicon solar cells, which typically have an energy conversion efficiency of approximately 15-18%. Manufacturers estimate that raising the average energy conversion performance of their production output by even 0.1% (for example, from 16% to 16.1%) would give them a substantial competitive advantage.

Polysilicon solar cells, made from the least expensive grades of silicon feedstocks, currently dominate the solar cell market. In order to offer volume product, solar cell manufacturers must generally process thin slices of polysilicon, which may be sawn from blocks or drawn as ribbons from a melt, as quickly as possible. These are “rough” processing procedures, and such solar cell manufacturing is relatively “low tech”, bearing little resemblance to the high precision fabrication techniques commonly employed for producing silicon microelectronic chips. As a consequence, solar cells typically contain many mechanical and electrical defects, which limit both the performance and service life of the solar cell. If solar cells contain microcracks which would later cause them to fail in service, cells containing such microcracks must be detected and rejected from the manufacturing line before too much money has been invested in further processing of those solar cells or before the defective solar cells are inadvertently shipped to customers. If the solar cells contain shunts (i.e., local spots where electrical efficiency is low due to variations in conductivity), these shunts must be isolated or corrected. Spotting defects and either fixing or rejecting unacceptable solar cells is critical for the yield and profitability of the solar cell manufacturer.

Although imaging methods are known which can “see” defects such as microcracks and shunts in silicon solar cells, at present these known imaging methods are slow, low in spatial resolution, and complex to operate, generally requiring highly trained personnel. Also, current imaging methods are incapable of quickly and precisely determining the type of defect; for example, a microcrack under some types of imaging may be confused with a region of inhomogenous doping. This can lead to inaccurate process adjustments.

One known method for visualizing defects in solar cells is lock-in thermography. More particularly, with lock-in thermography, the solar cells are periodically heated by applying a forward or reverse bias current to the cells, and then cracks or shunts” are detected by using sophisticated temperature-sensing cameras to locate tiny local temperature variations on the solar cells. These local temperature variations typically indicate “such spots. In other words, with lock-in thermography, a current is passed through the solar cell so as to heat up the cell, and then a temperature-sensitive camera is used to detect local temperature variations in the cell, and hence variations (i.e., defects) in the local structure of the cell. However, a research grade lock-in thermography system currently costs about $300,000, has low spatial resolution, and typically requires a highly qualified scientist to interpret the results. Thus lock-in thermography is generally not suitable for deployment on production lines.

Thus there is a need for a new and improved approach for detecting defects in solar cells on a production line.

### SUMMARY OF THE INVENTION

The present invention provides a new and improved approach for detecting defects in solar cells on a production line. More particularly, the present invention provides high resolution multimodal imaging for the non-destructive evaluation of polysilicon solar cells.

In one form of the invention, there is provided a non-destructive evaluation system for evaluating an article such as a test sample, the system comprising:

a silicon-based CCD camera for obtaining a series of images of the article;

first apparatus for receiving the series of images of the article from the silicon-based CCD camera and using a first imaging modality to generate a first data set spatially correlated to the article;

second apparatus for receiving the series of images of the article from the silicon-based CCD camera and using a second imaging modality to generate a second data set spatially correlated to the article; and

processing apparatus for processing at least one of the first and second data sets so as to evaluate at least one physical characteristic of the article.

In another form of the invention, there is provided a non-destructive evaluation system for evaluating a solar cell, the system comprising:

a silicon-based CCD camera for obtaining a series of images of the solar cell;

first apparatus for receiving the series of images of the solar cell from the silicon-based CCD camera and using a thermoreflectance (TR) modality to generate a first data set spatially correlated to the solar cell;

second apparatus for receiving the series of images of the solar cell from the silicon-based CCD camera and using a second imaging modality to generate a second data set spatially correlated to the solar cell; and

processing apparatus for processing both the first and second data sets so as to evaluate at least one physical characteristic of the solar cell.

In another form of the invention, there is provided a non-destructive evaluation system for evaluating a solar cell, the system comprising:

a silicon-based CCD camera for obtaining a series of images of the solar cell;

apparatus for receiving the series of images of the solar cell from the silicon-based CCD camera and using a stochastic resonance enhanced thermoreflectance (TR) modality to generate a data set spatially correlated to the solar cell; and

processing apparatus for processing the data set so as to evaluate at least one physical characteristic of the solar cell.

In another form of the invention, there is provided a method for evaluating an article such as a test sample, the method comprising the steps of:

generating a series of images of the article using a silicon-based CCD camera;

using a first imaging modality to generate a first data set spatially correlated to the article from the series of images generated by the silicon-based CCD camera;

using a second imaging modality to generate a second data set spatially correlated to the article from the series of images generated by the silicon-based CCD camera; and

processing at least one of the first and second data sets so as to evaluate at least one physical characteristic of the article.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view showing an image created via lock-in thermography;

FIG. 2 is a schematic view showing how the present invention may be used to detect subsurface cracks in a solar cell;

FIG. 3 is a schematic view showing apparatus for detecting thermoreflectance in a test sample;

FIG. 4 is a schematic view showing a typical thermoreflectance image;

FIG. 5 is a schematic view showing a low-resolution, scanning thermoreflectance image;

FIG. 6 is a schematic view showing cross-plane thermoreflectance imaging;

FIG. 7A is a schematic view showing thermoreflectance-based thermal imaging of a test sample;

FIG. 7B is a schematic view showing electroluminescence (EL) imaging of a test sample;

FIG. 8 is a schematic view showing multi-modal defect detection in accordance with the present invention;

FIG. 9A is a schematic view showing SRETR imaging of shunt in a solar cell;

FIG. 9B is a schematic view showing IR thermography imaging;

FIG. 9C is another schematic view showing IR thermography imaging;

FIG. 10A is a schematic view showing a stochastic resonance enhanced measurement of a periodic signal;

FIG. 10B is a schematic view illustrating SRETR imaging;

FIG. 11A is a schematic view showing a cell crack detector;

FIG. 11B is a schematic view showing a brightfield image from a multimodal crack detector;

FIG. 11C is a schematic view showing an EL image from a multimodal crack detector;

FIG. 11D is a schematic view showing an SRETR image from a multimodal crack detector;

FIG. 11E is a schematic view showing an efficiency map;

FIG. 12A is a schematic view showing LBIC mapping;

FIG. 12B is a schematic view showing EL imaging;

FIG. 13 is a schematic view showing hot spots in solar cell;

FIG. 14A is a schematic view showing an EL image of a solar cell;

FIG. 14B is a schematic view showing a DLIT image of a solar cell;

FIG. 14C is a schematic view showing a visible light image of a solar cell;

FIG. 15A is a schematic view showing an LBIC efficiency map of a solar cell;

FIG. 15B is a schematic view showing a line scan of a normalized photoresponse across a crack in a solar cell; and

FIG. 15C is a schematic view showing a fast efficiency mapping tool.

Table 1 shows a comparison of SRETR imaging and IR thermal imaging.

### DETAILED DESCRIPTION OF THE INVENTION

The present invention uses stochastic resonance enhanced thermoreflectance (SRETR) imaging, together with other complementary imaging modalities likewise supported by SRE, to deliver a defect location system which offers more than two hundred times the spatial detail (e.g., 4 megapixels vs. 20 kilopixels) of conventional lock-in thermography, with greater specificity in identifying the nature of the defects. Also, the new system is easier to use and interpret, and can be interfaced directly with automated manufacturing systems.

A significant aspect of the present invention is its use of stochastic resonance enhanced thermoreflectance (SRETR) imaging to detect solar cell defects. SRETR is a method of mapping energy flows in semiconductors which uses “off-the-shelf” CCD cameras to locate defects in silicon solar cells with high spatial resolution (e.g., 3000×2000 pixels). Stochastic resonance (SR) image processing is a computational algorithm which uses software to take advantage of noise-optimized non-linear effects in CCD cameras so as to yield higher signal-to-noise ratios than conventional lock-in imaging. For example, under appropriate conditions, stochastic resonance techniques can extract 12-bit images from an 8-bit camera. The technique of SRETR has been described in U.S. Pat. No. 7,429,735 and Mayer et al, J. Opt. Soc. Am. A/Vol. 24, No. 4/April 2007.

Stochastic resonance image processing techniques can be applied to visualize a variety of extremely weak physical effects which might otherwise be far too weak to yield practical images. By way of example but not limitation, stochastic resonance image processing techniques can be applied to spatially-distributed fluorrescence lifetime, photoluminescence (PL), electroluminescence (EL), thermoreflectance (TR), etc. In this respect it should be appreciated that, while stochastic resonance image processing has previously been used primarily in microscopy, the present application for solar cell inspection primarily involves macro-imaging.

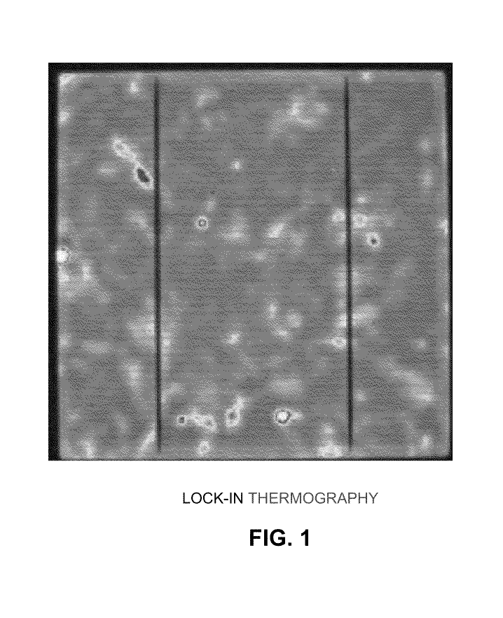

One method which has previously been studied for locating cracks or shunts or other defects in solar cells applies periodic current pulses to the solar cells (which may be forward biased or reverse biased) so as to create tiny temperature gradients which are indicative of defects in the cell. However, these thermal gradients and discontinuities are extremely small, both in temperature and spatial dimensions, and would require 16-20 bit cameras for detection—which are not possible in any conventional thermal infrared camera. (Note: bit depth in a camera relates to the number of discernible levels; thus, since an N bit camera allows 2̂N levels, an N bit camera can then “see” a contrast of one part in 2̂N). Some German work on lock-in thermography, which stimulates the solar cells with periodic current pulses and averages large numbers of frames over long periods of time, has yielded limited data as a research tool for studying shunts and local recombination sites in solar cells, which are generally the major sources of lost efficiency. See FIG. 1.

However, the lock-in thermography approach, infrared or otherwise, has not been widely accepted for solar cell characterization for several reasons. First, infrared thermography is fundamentally unsuited to characterizing silicon as a material due to the low emissivity of silicon in the infrared band. Thus infrared lock-in thermography of silicon solar cells requires the cumbersome step of coating the back side of the cell with a black paint. Second, even tiny microcracks may severely impact photovoltaic efficiency, but such tiny microcracks are usually hidden within large cells—so very high spatial resolution is required in order to locate these tiny microcracks. Even so-called “high end” thermal infrared cameras typically only have 320×240 pixels (i.e., approximately 77 kilopixels), a much lower resolution than a typical cell phone camera. Due to the difficulty of fabricating exotic pixel structures, thermal infrared camera pixel densities will likely never approach that of even an inexpensive digital camera CCD, which may have 3000×4000 pixels (i.e., approximately 12 megapixels). Third, lock-in imaging systems are generally expensive, and lock-in thermography systems are even more so, e.g., a lock-in thermography system typically costs about $300,000, which makes them impractical for use on a typical solar cell production line. Fourth, the thermal infrared band (8-12 μm) generally requires highly specialized IR optics, such as costly germanium lenses. For these, and other, reasons, lock-in thermography is fundamentally unsuitable for locating common solar cell defects such as metallic impurities (which typically have spatial dimensions on the order of micrometers) or cross-plane imagining of defects through the pn junction.

Thus, radically new methods for visually inspecting solar cells are needed by the industry.

A significant advance would be a system that can take advantage of the temperature discontinuity approach to quantifying defects and series resistance in solar cells, but with a very high spatial resolution, for more precise defect characterization, ease of use by untrained personnel, and much lower cost. However, since thermal gradients alone frequently do not tell the whole story, it would also be desirable for a single lock-in imaging system to include other modes of characterization which might be useful for inspecting solar cells, such as electroluminescence (EL). Combining different imaging modes based on different physics would lead to a powerful, integrated tool optimized specifically for the solar cell application. No such tool exists today.

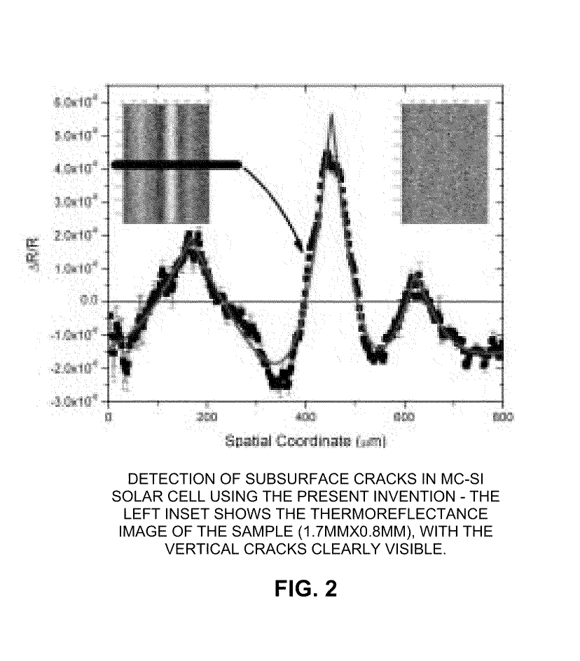

The present invention provides a new approach for the non-destructive evaluation (NDE) of solar cells. See FIG. 2. In the present invention, faint discontinuities—which signify the presence of hidden defects—are visualized using the recently developed technique of stochastic resonance enhanced (SRE) image processing, applied to various imaging modalities, including stochastic resonance enhanced thermoreflectance (SRETR).

### Stochastic Resonance (SR)

Stochastic Resonance (SR) software uses the principle of stochastic resonance for enhanced image processing. Stochastic resonance is not in and of itself a signal processing technique—rather, it is a physical effect whereby a weak periodic signal applied to a strongly non-linear system can be amplified providing that the optimal amount of noise is present; the “resonance” relates to the maximum in the curve of S/N vs. noise content. This seemingly paradoxical idea, whereby the introduction of just the right amount of noise into a signal can actually amplify (rather than degrade) a signal, was first discovered by geophysicists modeling the earth's history of ice age recurrences (≈10̂5 years) which are driven by small orbital oscillations of the earth enhanced by solar radiation fluctuations (i.e, the “noise”). Gammaitoni et al. [Rev. Mod. Phys. 70, p. 223 (1998)] explain how this idea has since been broadened to applications in biology, neuronal behavior and bistable phenomena, and can also be practically applied to engineer analog-to-digital conversion circuits.

The co-inventors of the present invention, Janice Hudgings and Rajeev Ram, and their co-workers, were the first to realize that a CCD camera is itself a strongly non-linear, quantized system and that—in the context of lock-in imaging, where a large number of faint images are stimulated by a periodic driving force—it might be possible to use SR techniques to see gray scale differences much smaller than the nominal bit depth of the CCD camera. In this case, the optimal introduction of noise should be about equal to the gap between two quantization levels—less and there will not be enhancement, and more and the noise will wash out the signal. Intuitively, the noise allows the signal to “taste” two adjacent levels, whereas otherwise it would sit undetected in between the two levels—and, statistically, it then becomes possible to better detect the signal. As a result, using stochastic resonance techniques, an 8-bit (256 levels) CCD camera may be able to yield for example 12-bits (4,096 levels) of gray scale by proper use of SR as a signal processing algorithm—but the tradeoff is that iteration of many image grabs are required. Thus, the stochastic resonance technique is a variant of lock-in imaging, and does not apply if only a single image is captured—and, therefore, the SR technique is not suitable for portable cameras. However, in the context of averaging a large number of registered images, and by applying the stochastic resonance (SR) technique to high spatial resolution CCD cameras, both high spatial resolution and high bit depth images can be obtained.

### Thermoreflectance (TR)

As noted, stochastic resonance enhancement for CCD cameras can be applied to many different low intensity scientific imaging modes such as photoluminescence (PL), etc. In particular, it may be applied to thermoreflectance (TR), which is a specialized technique for making temperature maps by measuring surface reflectance at some convenient wavelength, typically in the portions of the spectrum (e.g., 0.4-1.1 μm) where CCD cameras are operative.

Thus, the second part of our approach is to use stochastic resonance (SR) to enhance thermoreflectance (TR) imaging of solar cells—thereby resulting in stochastic resonance enhanced thermoreflectance (SRETR) imaging of solar cells.

Thermoreflectance (TR) is based on the fact that all materials show some dependence of optical reflectance on temperature. Thermoreflectance measures the fractional change in the surface reflectance ΔR/R at some convenient wavelength in response to surface temperature variations ΔT=k ΔR/R; this is related to the thermo-optic effect, whereby refractive index changes with temperature.

Knowledge of the thermoreflectance coefficient k, which is strongly material-dependent, enables the determination of ΔT from the measured ΔR/R. Although, in general, the thermoreflectance (TR) effect is extremely small, it is relatively stronger in the case of multicrystalline silicon (mc-Si) than for many other materials, with κ=2×10⁻³ K⁻¹ for a probe wavelength of 630 nm. Although the basic concept of thermoreflectance has been known for years, recent advances in image processing developed by the co-inventors of the present invention, Janice Hudgings and Rajeev Ram, have made it a more practical and sensitive technique, as shown by the impressive results from microscopic imaging of optoelectronic devices containing silicon, GaAs, InP, or other semiconductors.

If the faint thermoreflectance (TR) effect can be made detectable, advantages can be obtained which are not matched by any other semiconductor imaging technique—principally in terms of spatial resolution. Since this method uses standard visible light CCD's, high pixel densities (e.g., 3000×2000) are available at relatively low cost. Furthermore, the use of shorter visible wavelengths in itself allows higher spatial resolutions.

Stochastic resonance (SR) image processing, and its applications to thermoreflectance (TR) so as to yield the technique of stochastic resonance enhanced thermoreflectance (SRETR), are further described in U.S. Pat. No. 7,429,735, issued Sep. 30, 2008 to Lueerssen et al. for HIGH PERFORMANCE CCD-BASED THERMOREFLECTANCE IMAGING USING STOCHASTIC RESONANCE, which patent is hereby incorporated herein by reference, and in Mayer et al., “CCD-based thermoreflectance imaging”, JOSA Vol. 24, p. 1156, April, 2007, which document is hereby incorporated herein by reference.

### Application of Stochastic Resonance Enhanced Thermoreflectance (SRETR) to Solar Cells

With the present invention, the co-inventors have discovered how the stochastic resonance enhanced thermoreflectance (SRETR) technique is particularly amenable to use with multicrystalline silicon, so that it can be used for non-destructive evaluation (NDE) of solar cells and provide superior resolution and greater sensitivity to smaller defects.

It has also been discovered that it is possible to use stochastic resonance enhanced thermoreflectance (SRETR) to characterize features in addition to surface defects. More particularly, it has been discovered how stochastic resonance enhanced thermoreflectance (SRETR) can be used to determine the depth of subsurface defects relative to the solar cell pn junction using the thermoreflectance images.

And it has been discovered how stochastic resonance enhanced thermoreflectance (SRETR) can be used for the active repair of cells, by enabling the mapping of series resistance and device efficiency with unprecedented resolution, and thereby facilitating the use of laser scribing to eliminate poorly performing regions and increase overall device efficiency.

And it has been discovered how to apply stochastic resonance enhanced thermoreflectance (SRETR) to cross-plane imaging of defects in solar cells, i.e., for 3D sectioning of the solar cell image.

In the past, thermoreflectance has been largely a research technique of microscopy and has rarely been demonstrated for macro-imaging applications. Also, thermoreflectance as used in the past captures images too slowly for use in a production environment. The inventors are developing methods for much faster SRETR.

### More Details about Stochastic Resonance Enhanced Thermoreflectance (SRETR) as Applied to Solar Cells

1. Enhanced Spatial Resolution. Significant defects, metallic inclusions, and shunts in solar cells typically occur at length scales of approximately 200 nm-1 mm, making them difficult to detect by conventional methods. In contrast, the stochastic resonance enhanced thermoreflectance (SRETR) imaging of the present invention, using visible light and low cost, “off-the-shelf” commercial CCD cameras, can easily achieve these spatial resolutions. By way of example but not limitation, thermoreflectance-based NDE of photonic devices, using a visible light, 652×494 pixel CCD costing only a few hundred dollars, has already achieved a spatial resolution of 250 nm. Furthermore, it is believed that two orders of magnitude improvement in this spatial resolution can be successfully applied to NDE of solar cells using the present invention.

2. Enhanced Thermal Resolution. Thermoreflectance (TR) depends for its sensitivity on advanced computational algorithms. The computational approach of the present invention effectively performs lock-in signal detection with a CCD camera on a pixel-by-pixel basis, enabling the extraction of both the amplitude and phase of the surface temperature response with better than 250 nm spatial resolution (in microscopic mode). Stochastic resonance enhancement (SRE) results in a thermal resolution that exceeds what previous researchers considered the practical limit by two orders of magnitude. Stochastic resonance enhanced thermoreflectance (SRETR) uses naturally occurring zero-mean noise sources (for example, thermal noise in an uncooled CCD camera) to enable sub-quantization-limit imaging. Without this enhancement, the finite bit-depth of CCD cameras would set a limit on the dynamic range of the thermoreflectance measurements. For example, with a 12 bit camera and a favorable test material, the unenhanced thermal resolution would be on the order of 1K. With the stochastic resonance enhanced technique, however, thermal resolutions of 0.01 K are achievable.

Achieving a thermal resolution on the order of 1 mK, which would aid in detection of more subtle solar cell shunts, is a technical challenge. The present invention provides a way to meet this challenge, by tuning the illumination wavelength so as to exploit resonances in the reflectance spectrum of polysilicon. It is believed that an order of magnitude improvement in the calibration value k can be obtained by tuning the illumination wavelength so as to exploit resonances in the reflectance spectrum of polysilicon.

This novel approach is particularly significant for silicon solar cells, because solar cells, in order to absorb the maximum sunlight for conversion into electricity, are designed to be as non-reflective as possible over the main spectrum of sunlight (i.e., approximately 400-1100 nm). This is typically accomplished by texturing the solar cells and applying thin film anti-reflective coatings to the solar cells. Since stochastic resonance enhanced thermography (SRETR) relies on some reflectance, however, a completely anti-reflective solar cell would not make a good subject for SRETR analysis. However, as a practical matter, solar cell anti-reflection technology is imperfect, especially at the blue end of the spectrum. Therefore, since the stochastic resonance enhanced thermography (SRETR) technique has the flexibility to be used at a variety of probe wavelengths, operating parameters can be chosen so as to capture a sufficiently strong reflection signal.

### More About Stochastic Resonance Enhanced Thermography (SRETR)

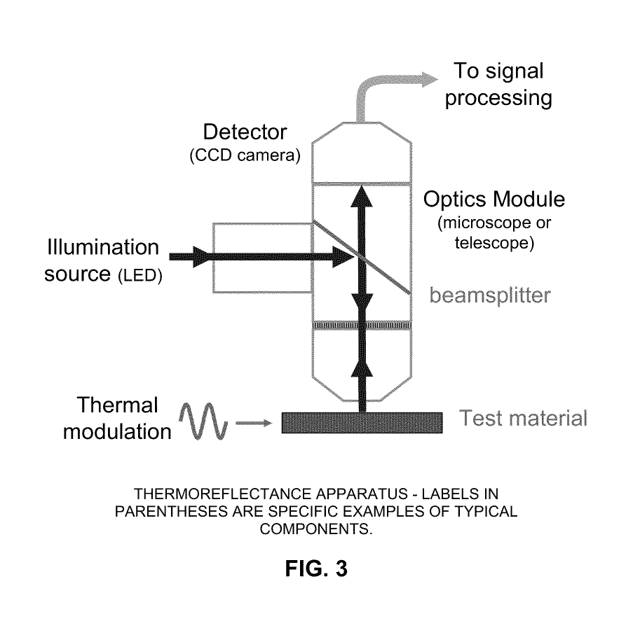

A typical CCD-based thermoreflectance system is shown in FIG. 3. Visible light from an LED (or other light source) illuminates the surface of the test sample, and the back-reflected light is imaged onto a standard CCD camera, providing a 2-D image of reflections from the sample surface. The camera is then synched to a periodic current stimulating the test sample, and a lock-in method is used to iterate over many image captures. The spatial resolution and size of the area measured depend on the choice of optics, with a microscope used to obtain high spatial resolutions (250 nm) or a telescope for large-area applications.

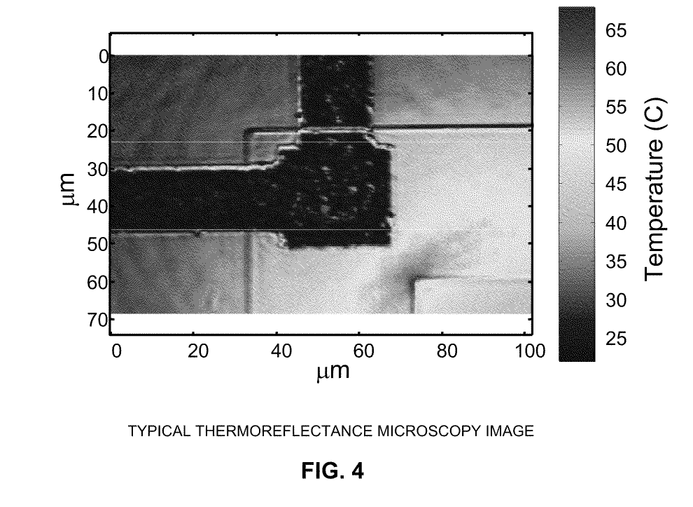

FIG. 4 shows a high definition, high thermal resolution thermoreflectance (TR) image of an electronic component (in this case, a silicon resistor).

To use a lock-in technique, the CCD camera is preferably triggered at four times the frequency at which the stimulating current (and hence the temperature of the sample) is modulated, and signal processing techniques are used to extract the amplitude and relative phase of the corresponding ΔR/R on a pixel-by-pixel basis.

The CCD-based thermoreflectance lock-in averaging is then further processed using the aforementioned stochastic resonance technique, thereby enabling temperature resolutions of 10 mK (in the case of gold).

Furthermore, with the present invention, an order of magnitude further improvement is achievable in the thermal resolution on polysilicon solar cells (1 mK expected), because the signal is an order of magnitude stronger for polysilicon than it is for the gold surfaces on which the 10 mK thermal resolution was determined.

Thus, thermoreflectance enables non-contact, two-dimensional (2D) temperature mapping with a sub-micron spatial resolution that is unavailable by any other lock-in method, using only widely available, low cost visible light cameras supplemented by computational algorithms. Furthermore, due to the relatively higher signal obtainable with polysilicon, even higher spatial resolution is obtainable when testing polysilicon solar cells.

### Thermoreflectance for Defect Detection and Efficiency Mapping in Solar Cells

The thermoreflectance (TR) technique of the present invention can be performed with access to either side of the solar cell. Typically, to detect shunts (which are defined as sites of increased local current density under forward bias), the solar cell is reverse voltage biased under zero illumination conditions. (Note that the TR measurements can be made on the rear side of the solar cell, so that the TR illumination source does not confound the results.) The reverse bias voltage is sinusoidally modulated, so that the increased current flowing through the shunts causes localized heating at the same modulation frequency. The resulting magnitude signature in the surface temperature distribution yields a topographic map of the shunt position. Furthermore, quantitative information such as the local IV characteristic at the shunt position can be extracted from the signal, enabling the user to extract information about the underlying physical origin of a shunt, thereby allowing processing parameters for the solar cells to be quickly corrected.

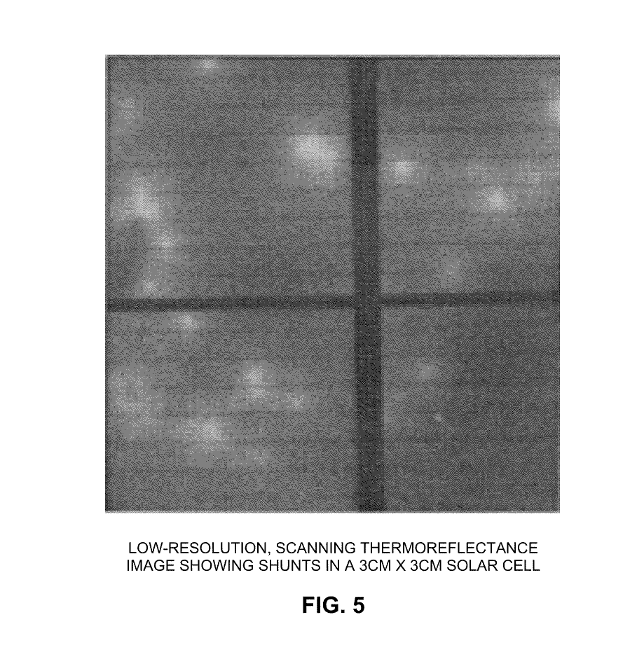

FIG. 2 shows identification of three parallel subsurface cracks in a multicrystalline-Si solar cell using the method of the present invention. Significantly, none of these cracks is visible to the naked eye. Others have demonstrated the use of a low-resolution scanning thermoreflectance technique to locate shunts in solar cells; see FIG. 5.

### Summary of Strengths and Limitations of Stochastic Resonance Enhanced Thermoreflectance (SRETR)

In summary, it has been found that stochastic resonance enhanced thermoreflectance (SRETR) has ideal characteristics for solar cell characterization:
SRETR is well suited for the examination of silicon, which long wavelength methods are not.
SRETR has very high spatial resolution due to large pixel densities and visible wavelengths.
SRETR does not require the development of a new camera—it uses a software algorithm which works with any off-the-shelf CCD camera.
SRETR data can be folded together with other imaging modalities—such as photoluminescence (PL)—for carrier lifetime mapping, enabling an integrated solar cell characterization tool.
A SRETR system consists of an off-the-shelf CCD camera and software, so its cost is potentially low.

However, SRETR also has one significant challenge:
At present, SRETR is slow to compute an image due to the lock-in method requiring many iterations.

### More Details

In accordance with the present invention, thermoreflectance imaging may be used to characterize the local IV response of a variety of types of shunts, and hence characterize different types of shunts, with highly improved thermal resolution (˜1 mK) and highly improved lateral spatial resolution (˜250 nm).

Also in accordance with the present invention, phase information in the thermoreflectance signal can be used to determine the relative depth of localized shunts. More particularly, thermal waves propagate from a buried, localized shunt to the surface of the cell with a thermal diffusion length that goes as the inverse square root of the lock-in frequency (f^{-1/2}). Thus, depth resolution can be obtained from the frequency-dependent phase signature. While such phase information is sometimes used for depth resolution of defects in the field of NDE of materials, this information is commonly neglected in scientific lock-in imaging.

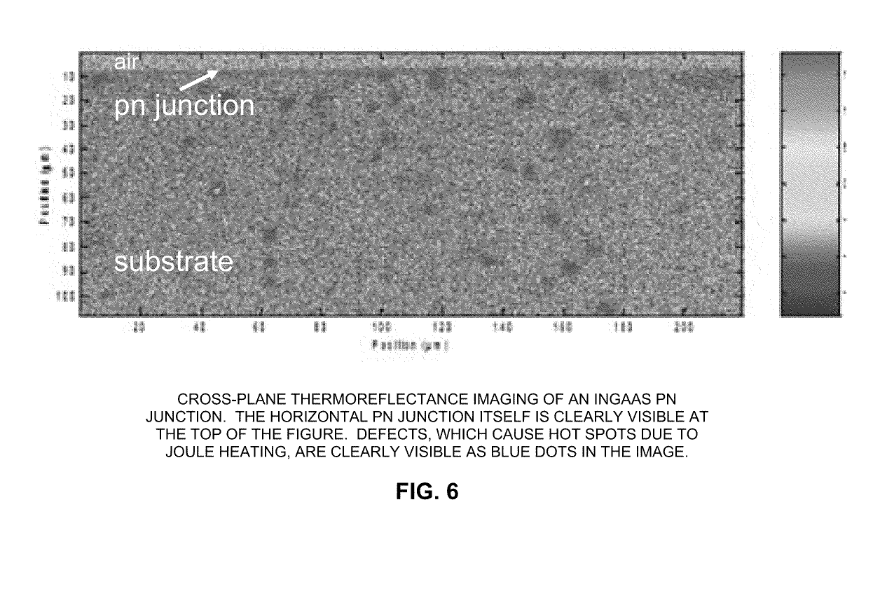

And in accordance with the present invention, cross-plane imaging of the pn junction of the solar cell can be used to determine the relative position of defects. More particularly, the most direct method for determining the depth at which defects occur relative to the pn junction is to image the defects cross-plane, which can be done by exploiting the ultra-high spatial resolution of the enhanced thermoreflectance (TR) imaging provided with the present invention. See, for example, FIG. 6, in which the pn junction is readily apparent on the image, as well as the presence of defects. This type of visualization is not possible using conventional lock-in thermography because of the poor spatial resolution provided by such conventional systems. However, since this is a destructive technique, requiring slicing of the solar cell at defect locations, this is primarily useful as an industrial research tool, as solar cell manufacturers adjust their growth and fabrication techniques to incorporate advanced new techniques such as metal defect nanoengineering for isolating defects away from the pn junction.

And in accordance with the present invention, thermoreflectance can be used to map the local series resistance and device efficiency of silicon solar cells, thereby enabling laser scribing of defects. More particularly, for illuminated solar cells forward-biased near the maximum power point, regions of unusually high series resistance appear as “cold spots” in the thermal profile, after minor image processing to eliminate confounding effects. To implement single-sided illuminated thermoreflectance imaging, a two-color illumination is used, with a CW reflectance probe at 630 nm as usual and a modulated illumination source at 470 nm, where the solar cell reflectance is high. The CCD camera is locked to the illumination source. Alternatively, this can be implemented as a two-sided technique, with thermoreflectance (TR) imaging of the rear side of the cell.

In addition, the resulting temperature maps can be used in conjunction with a total energy balance model to extract the spatially resolved efficiency of the cells under illuminated operating conditions.

### Combining Other Image Modalities with Stochastic Resonance Enhanced Thermoreflectance (SRETR) for Solar Cells

Valuable spatially-resolved information about the performance, efficiency and defect maps of polysilicon solar cells can be obtained from two dimensional (2D) characterization techniques including infrared thermography, electroluminescence (EL), photoluminesence (PL) and photoconductivity scans. To date, however, these characterization techniques have, for the most part, remained research techniques with little penetration into the photovoltaic (PV) manufacturing supply chain, where the emphasis is on high production throughput, yield, and real-time location, isolation or repair of defects. All of these characterization methods have suffered from inadequate spatial resolutions, slow image capture times, and very high equipment costs. There has also been a lack of integration: separate instruments are required to locate shunts or map carrier lifetimes, etc., and no single system has heretofore combined data from several of these imaging modes to give the process engineer exactly the information needed to optimize photovoltaic (PV) production. Also, most available instruments require a highly trained scientist to operate the equipment and interpret the results.

The present invention includes an integrated approach to high resolution, low cost, multimodal solar cell characterization. This integrated approach, in which a single CCD camera is used for a variety of measurement modalities (e.g., thermal, electroluminescence, etc.) enables results from the various measurements to be combined together so as to extract far more detailed, quantitative, high resolution, 2D information about defects, carrier lifetime, junction quality, and series resistance of solar cells than can be obtained from the single stand-alone measurements currently offered. This integrated approach, using a single imager, is not possible with currently available technology, because thermal imaging is done with specialized IR cameras whereas the majority of other measurements are done in the visible or near-IR spectrum.

Therefore, the fact that the stochastic resonance enhanced thermoreflectance (SRETR) analysis of the present invention uses visible light, which can be seen by a CCD camera, as opposed to infrared light, is the key which permits the integration of thermal mapping with several additional modalities in a single system, and is a key element of the present invention.

The integrated solar cell non-destructive evaluation (NDE) system of the present invention relies on two major technical advances in order to achieve very high resolution imaging over a range of measurement modalities with only a Si-CCD camera: (1) stochastic resonance enhanced imaging, and (2) thermoreflectance imaging. As noted above, stochastic resonance enhanced (SRE) imaging is an advanced computational method for the reliable detection of extremely small image signals. The co-inventors have used this method to create a new approach to thermography, based on thermoreflectance, using visible light rather than infrared light, with major practical advantages. Stochastic resonance enhanced thermoreflectance (SRETR) uses off-the-shelf Si-CCD cameras which have higher pixel counts than typical infrared cameras, and is able to detect mK temperature gradients with much higher spatial resolution at much lower system cost than infrared methods. Moreover, it has now been discovered that the same basic stochastic resonance enhanced (SRE) imaging system can be used in other modes to observe electroluminescence (EL), photoluminescence (PL), photo-conductivity, mechanical deflection, visible light emission, standard visible imaging, local resistance maps, local efficiency maps, etc., and thereby to map in 2D such properties as minority carrier lifetimes, shunts, junction quality, etc. Microcrack defects can also be located by the same workstation.

These distinct imaging characterization modes, including thermography, electroluminescence (EL), photoluminescence (PL), photo-conductivity, mechanical deflection, visible light emission and standard visible imaging, can be accommodated within the same stochastic resonance enhanced (SRE) imaging workstation/visible light camera used for the thermoreflectance (TR) testing of the present invention. The imaging modes can be implemented either using stochastic resonance enhanced (SRE) techniques or traditional lock-in techniques, or they can be operated in the traditional DC manner.

Furthermore, this multimodal imaging tool can be used to develop integrated approaches to non-destructive evaluation (NDE) in which the characteristic signatures from the various measurement modes are combined to extract more detailed, sophisticated 2D mapping of performance markers (e.g., carrier lifetime, series resistance, shunts, junction quality, contact resistance, cracks, etc.) than is available from any single NDE measurement.

And the present invention can be used to address inspection problems encountered in the manufacture of solar cells such as the detection of microcracks, e.g., as may be introduced by sawing or other process steps.

Microcracks are problematic for polycrystalline silicon solar cells in three ways: (1) they cause mechanical weak points that can lead to cell breakage during manufacturing processing and packaging, thereby reducing yield; (2) they create inhomogenities that decrease photovoltaic (PV) operating efficiency; and (3) they reduce installed service life by causing the solar cells to fail or be degraded by environmental temperature cycling or wind related flexure. Furthermore, the scale of the cracks that need to be identified has become smaller as manufacturers attempt to use thinner silicon.

Non-destructive evaluation (NDE) and non-destructive inspection (NDI) techniques are needed for characterizing the resulting defects, cracks, metallic inclusions, shunts, regions of variant processing, etc. and determining their impact on device performance. However, all currently available solar cell characterization techniques have various limitations in performance, flexibility, portability, and/or cost, and performance data are not readily comparable between techniques. None of the currently available solar cell characterization techniques has become universally adopted as a process control tool.

Promising spatially-resolved NDE techniques currently used in research labs include thermal IR cameras, electroluminescence (EL) in two wavelength bands, visible imaging, <880 nm emission, and photoluminescence (PL), among others. 2D imaging is the preferred approach, as raster scanning techniques are too slow, e.g., NREL reports image capture times of 15-20 minutes for a single solar cell using commercial μ-PC scanning. Conventional thermography is effective as a way to find “hot spots”, but it relies on expensive, long-wavelength IR cameras, and tends to suffer from poor spatial resolution and signal-to-noise-ratio, leading to large uncertainties in measured values (e.g., series resistance) and difficulty in detecting highly localized defects (e.g., shunts, microcracks, etc).

Furthermore, NDE techniques have traditionally been considered in isolation, whereas recent research suggests that better defect characterization may be available by combining information from different methods. For example, current crack detection techniques suffer from a high rate of false positives, because they may misidentify as cracks certain image artifacts from other types of defects.

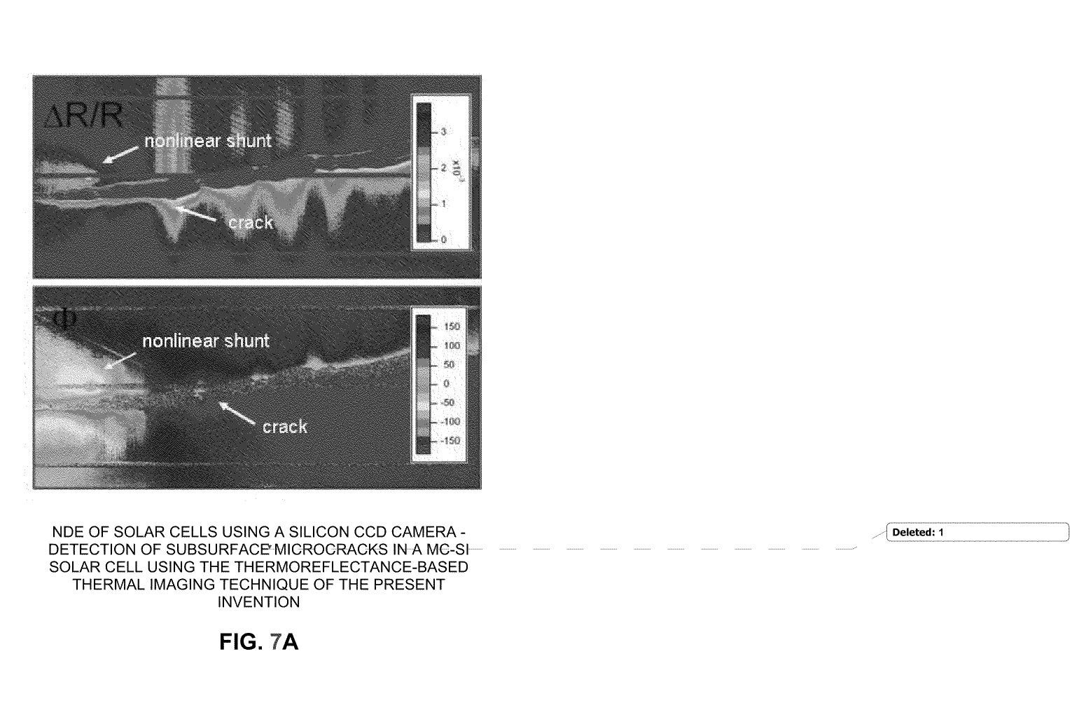

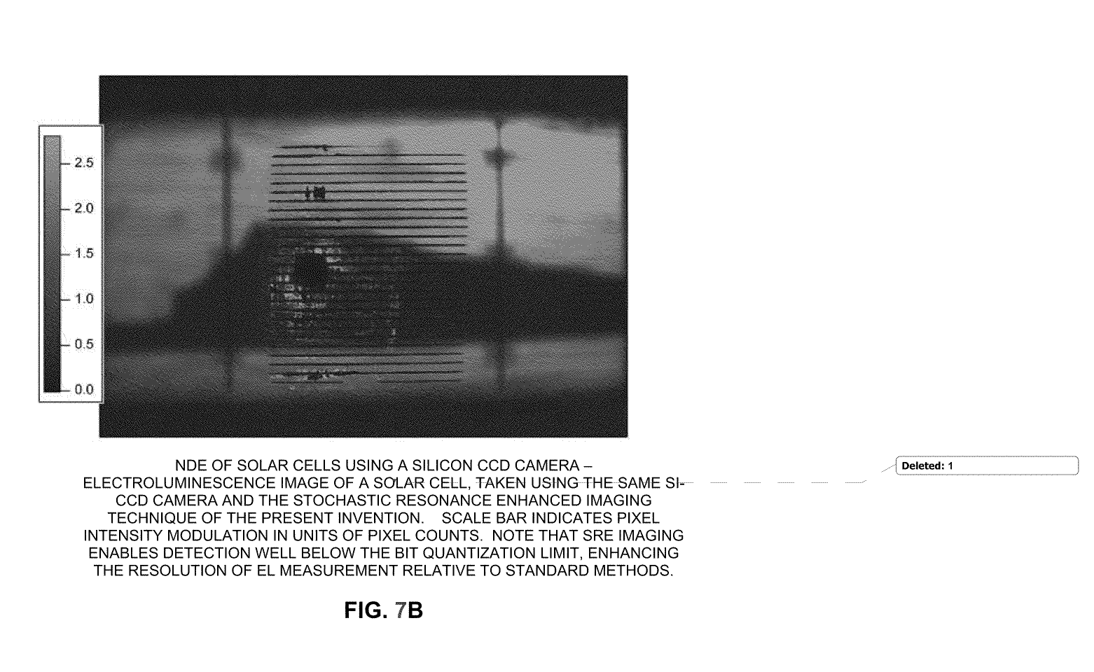

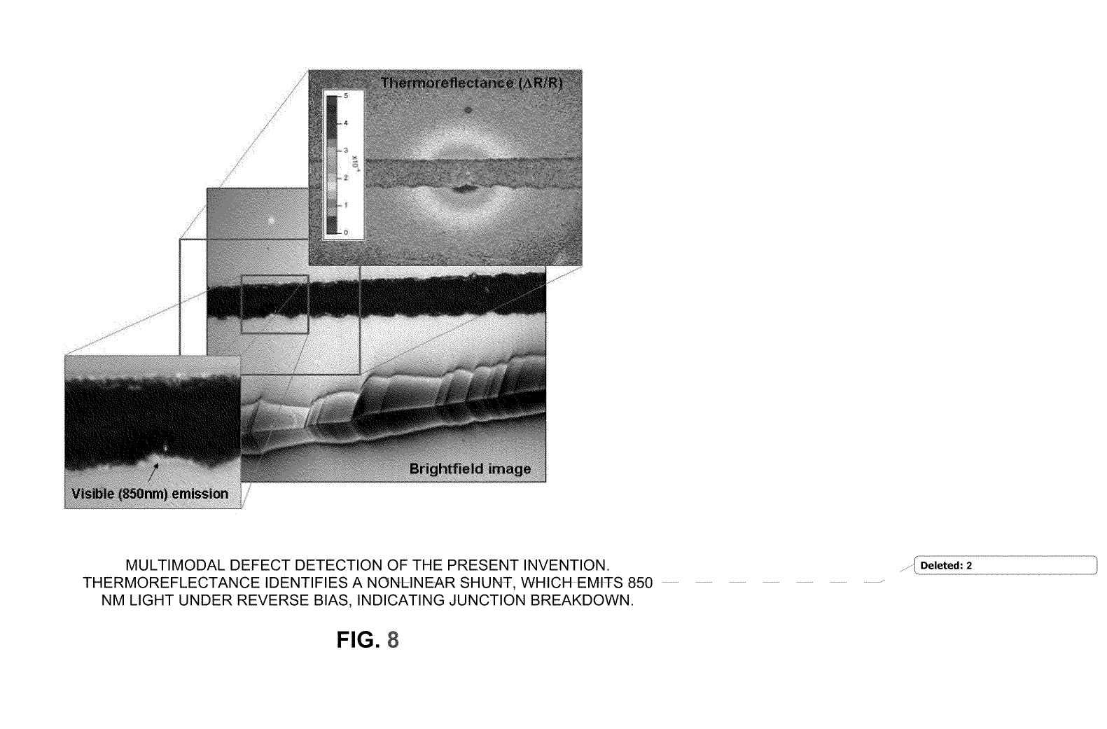

The present invention provides an enhanced 2D imaging technique for integrated NDE of solar cells which offers improvements on all of the above factors. The present invention combines multiple imaging modalities in a single, visible-light-based hardware system and then cross-correlates data from these independent physical measurements (FIGS. 7A, 7B and 8). By merging the results of multiple measurements using high speed algorithms, the present invention achieves very high sensitivity, reduced false positives, and distinguishes between various types of defects. An example of the power of multimodal imaging is shown in FIG. 8—thermoreflectance (TR) imaging detects a non-linear shunt under an electrical contact, while visible imaging detects 850 nm emission at the same location. These two measurements enable the operator or a smart automated software system to conclude that this is a region of poor junction quality, rather than a number of other interpretations which would be possible for either image considered alone.

The primary mode of the present invention is low cost, high resolution thermography using the stochastic resonance enhanced thermoreflectance (SRETR) imaging technique, which enables thermal imaging in the visible wavelength range. This thermoreflectance imaging technique offers a two order of magnitude improvement in spatial resolution (250 nm) compared to IR thermal imaging, due to the use of shorter wavelength light as well as the much larger number of pixels available in off-the-shelf CCD visible cameras. In addition, the present invention offers an order of magnitude cost reduction. Significantly, because it is based on visible light cameras, the system can also include other solar cell characterization modes (e.g., electroluminescence, etc.), preferably also enhanced by stochastic resonance enhanced (SRE) image detection, in order to obtain improved speed and resolution. This approach enables precise, quantitative determination of local series resistance, minority carrier lifetime, and other key measures of solar cell performance. By integrating the data from multiple measurement modes, the present invention provides new capabilities for comparing defect signatures across measurements (electroluminescence, thermal, etc). FIGS. 7A and 7B show microcrack detection in a solar cell and an electroluminescence image, both taken using the same camera and both processed using the same stochastic resonance enhanced (SRE) image processing software.

Thus, it is an object of, and a feature of, the present invention to apply stochastic resonance enhanced (SRE) imaging techniques not just to thermoreflectance (TR) but also to electroluminescence (EL) images, images of visible emission from the cell in the sub-880 nm range, photoluminescence (PL), micro-photoconductivity (μ-PC), mechanical deflection, local resistance maps, and local efficiency maps. Each of these modalities lend themselves to lock-in imaging, and furthermore to lock-in imaging in the visible spectrum, using the CCD cameras of the present invention.

Lock-in signal processing means that a physical phenomenon of some kind is stimulated periodically by some input stimulation, which could be a periodic light flash or modulated light signal, or a periodic electrical signal, or even a periodic acoustical signal. The phenomenon which is stimulated is then synched physically to the periodicity of the probe. For example, in the case of electroluminescence (EL), the input periodic signal is electrical current passed through the cell; the output, whose periodic time behavior tracks that of the electrical input, is an emission of light.

Thus it is known that the desired output signal will occur at a certain definite periodicity in time and no other. On the other hand, noise is a random phenomenon and is not synched. This observation can be used to discriminate the signal from noise very efficiently. Lock-in signal processing allows the resulting output, which may be of small magnitude, to be amplified by a narrow-band amplifier only at the frequency of stimulation. As a result, the noise accompanying the weak signal is suppressed by a very large factor, typically 10̂6 or even more.

Lock-in imaging applies this procedure to each separate pixel of a camera and allows weak images to be detected in the presence of noise.

Stochastic resonance enhanced (SRE) lock-in imaging further suppresses noise and enhances the image visibility.

In the integrated system of the present invention, lock-in imaging and stochastic resonance enhanced imaging may be applied to all of the aforementioned physical effects in one system, and the resulting data combined for analysis.

Thus, the combination of various imaging modalities, such as thermoreflectance (TR) and electroluminescence (EL) and photoluminescence (PL), all of which yield visible light signals, may be integrated in a single system which uses stochastic resonance enhanced (SRE) lock-in imaging to detect them, both severally and in combination.

This combination of imaging modalities is far more than the sum of the parts, because defects such as microcracks may show up in one mode but not another, or in several modes, whereas shunts may show up in a different set of imaging modes. This allows shunts to be distinguished from cracks, even though no one imaging mode allows such discrimination by itself.

The ability of the present invention to provide high resolution, high signal-to-noise ratio thermal, electroluminescence (EL), etc. measurements with a CCD camera relies on two fundamental advances: the enhanced thermoreflectance thermal imaging technique and stochastic resonance enhanced imaging.

### Comparison of Thermoreflectance (TR) and Conventional Lock-in IR Thermography for Application to Solar Cells

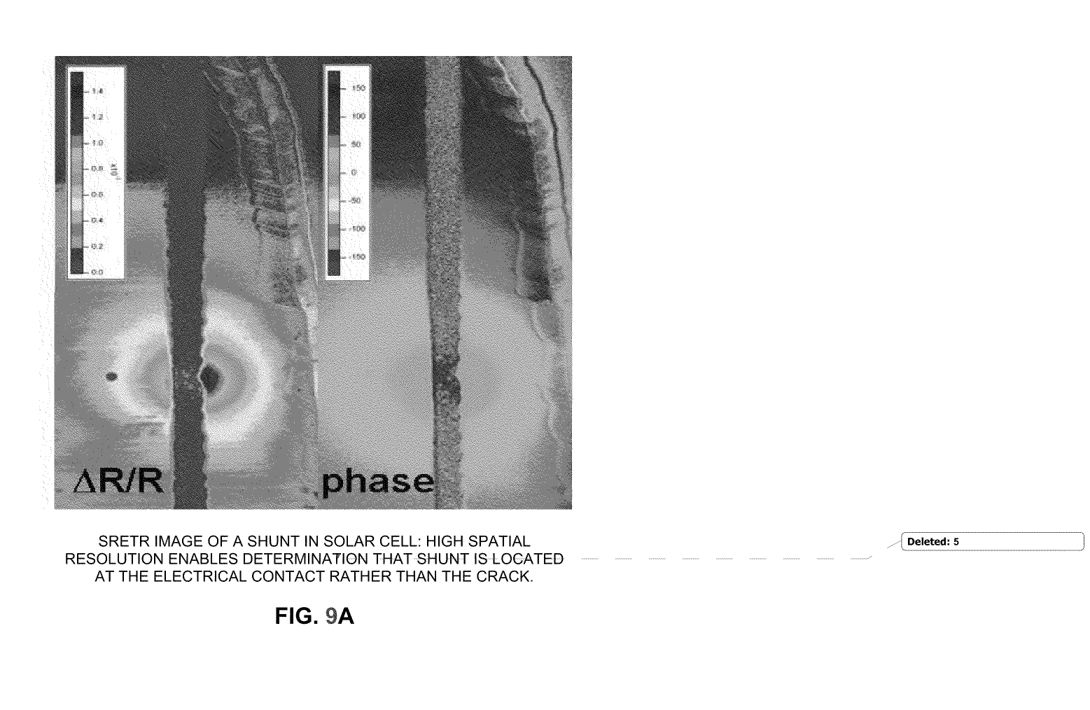

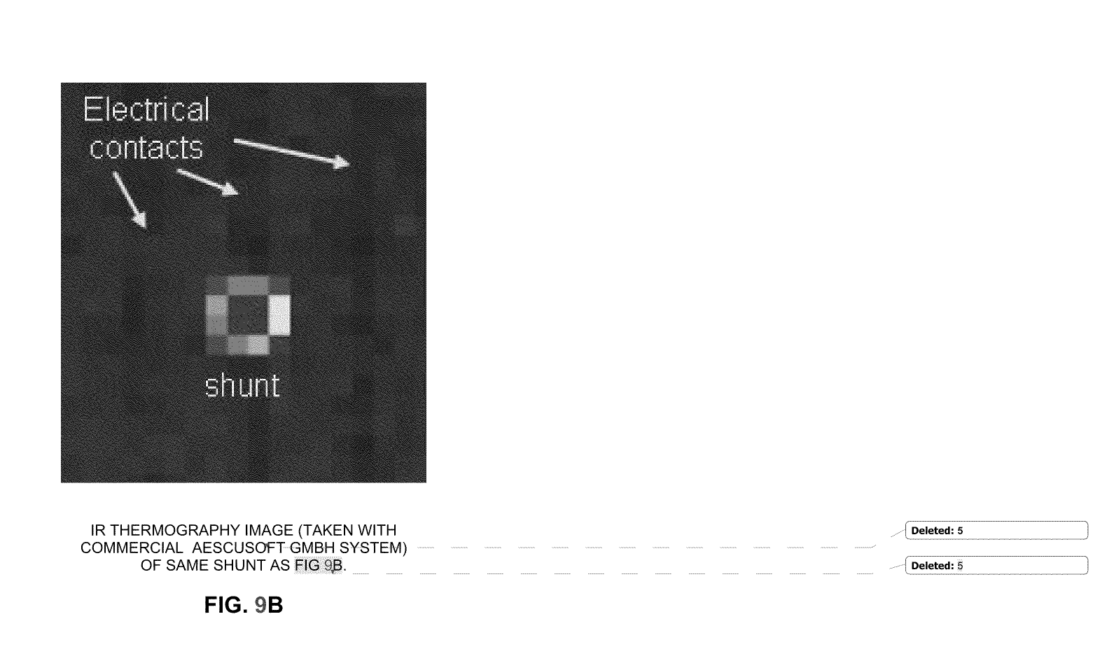

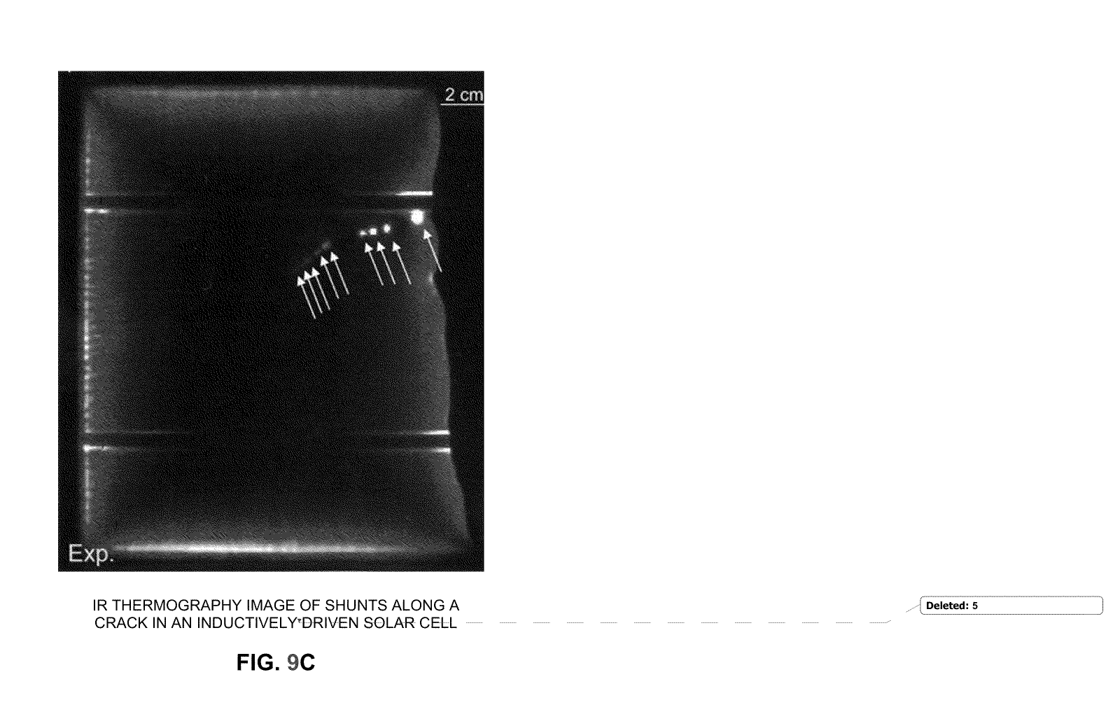

Table 1 summarizes the comparison between thermoreflectance (TR) and conventional lock-in IR thermography for application to solar cells. While IR thermography is not ideal for solar cells due to the relatively low emissivity of silicon, there is a very strong thermoreflectance response on mc-Si. IR thermography is fundamentally limited by the poor spatial resolution inherent in long wavelength, low pixel-count IR cameras. Furthermore, significant defects, cracks, metallic inclusions, and shunts can occur on length scales for which long wave infrared is unsuited; see FIGS. 9A, 9B and 9C. Infrared lenses are also expensive, and fiber optics are very limited.

By using shorter wavelength visible light, thermoreflectance (TR) offers an order of magnitude improvement in spatial resolution relative to IR thermography, enabling imaging at the length scale of grain sizes in typical mc-Si solar cells. Furthermore, by using visible light which can be seen by a CCD camera, the present invention lends itself to multimodal imaging.

Thermoreflectance (TR) does, however, suffer from slow response because of the multiple iterations required to perform lock-in thermography, needing time (seconds or minutes) to accumulate an image.

### Stochastic Resonance Enhanced (SRE) Imaging

For many solar cell NDE measurements, e.g. electroluminescence (EL), the signal being measured is quite small, so that conventional imaging yields low resolution images. Also, in conventional 2D imaging, the dynamic range of the image is limited by the bit depth of the camera (e.g., a 12-bit camera has amplitude resolution of one part in 4096). Stochastic resonance techniques can be applied to a wide range of imaging, including electroluminescence (EL) as well as thermoreflectance (TR).

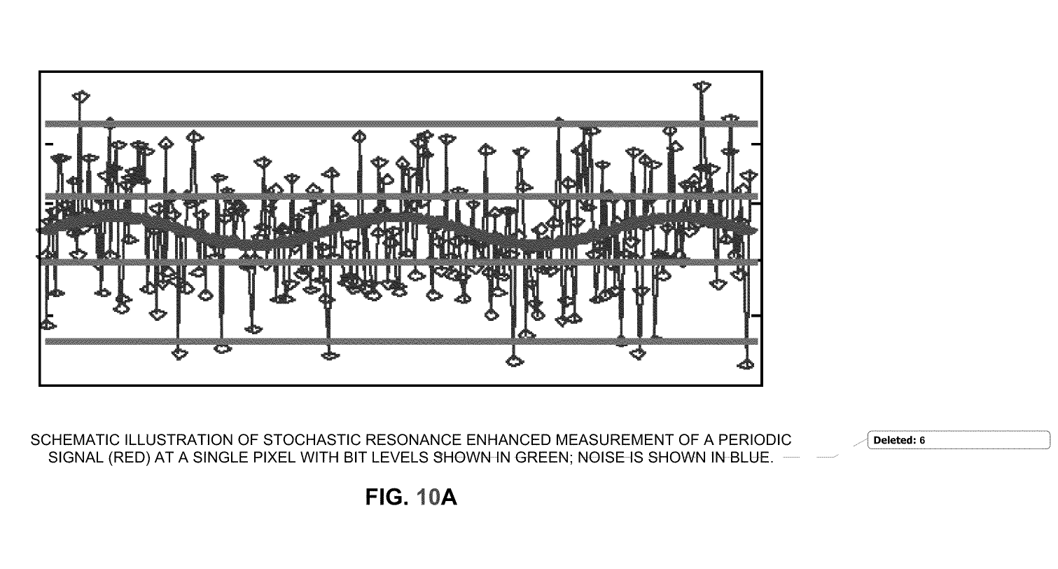

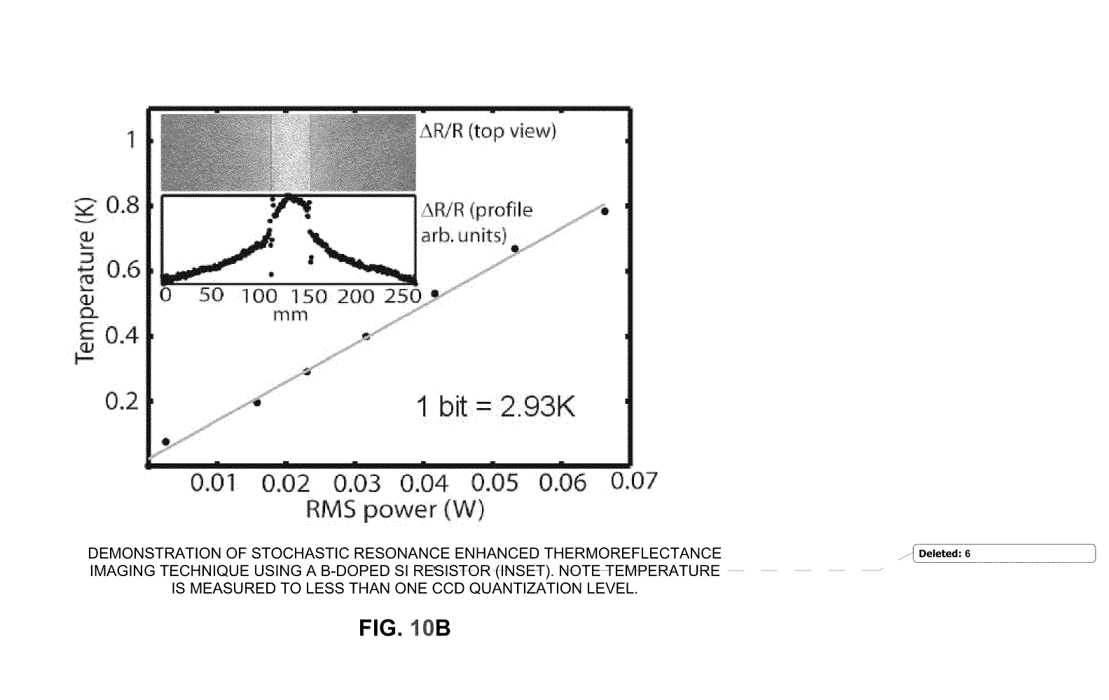

FIGS. 10A and 10B illustrates the basic idea of stochastic resonance applied to a digital imager. If the variation in a signal is less than the quantization gap between two camera grey levels, the signal is normally undetectable. However, if instead that same signal is imaged in the presence of white noise, the noise will distribute the signal across multiple bit levels, yielding a (noisy) non-uniform measured signal. If the noise content is optimum and the signal is averaged over many iterations, it may be shown that a net amplification results. FIG. 7A shows a stochastic resonance enhanced electroluminescence (EL) image captured in the lab. FIG. 10B shows a more quantitative example.

Stochastic resonance enhanced (SRE) imaging can be used wherever appropriate (TR, EL, etc.) with the various imaging modalities offered by the system's integrated NDE tool, offering substantial gains in resolution and signal-to-noise ratio (SNR). Alternatively, lock-in techniques or standard DC imaging can be used instead of, or in combination with, SRE-enhancement.

### Defects or Parameters that can be Measured

The various imaging modes can be used individually, or in combination with one another, to map series resistance, local operating efficiency, local IV curves, minority carrier lifetime, pn junction quality including early breakdown sites, contact resistance, metallization flaws, shunts, and mechanical defects such as cracks, inclusions, voids, flaws, poor layer contact, etc. In addition, the diode ideality factor and various electrical operating characteristics can be extracted.

### One Preferred Solar Cell NDE System

One preferred solar cell NDE system formed in accordance with the present invention uses a single apparatus to perform whole-cell imaging or high resolution partial-cell imaging to effect multiple physical measurements, including electroluminescence (EL) imaging, thermal imaging, and visible (<880 nm) emission imaging. Additional measurement modes can include efficiency mapping, photoluminescence (PL) mapping, mechanical deflection maps, resistance maps, photoconductivity maps, etc.

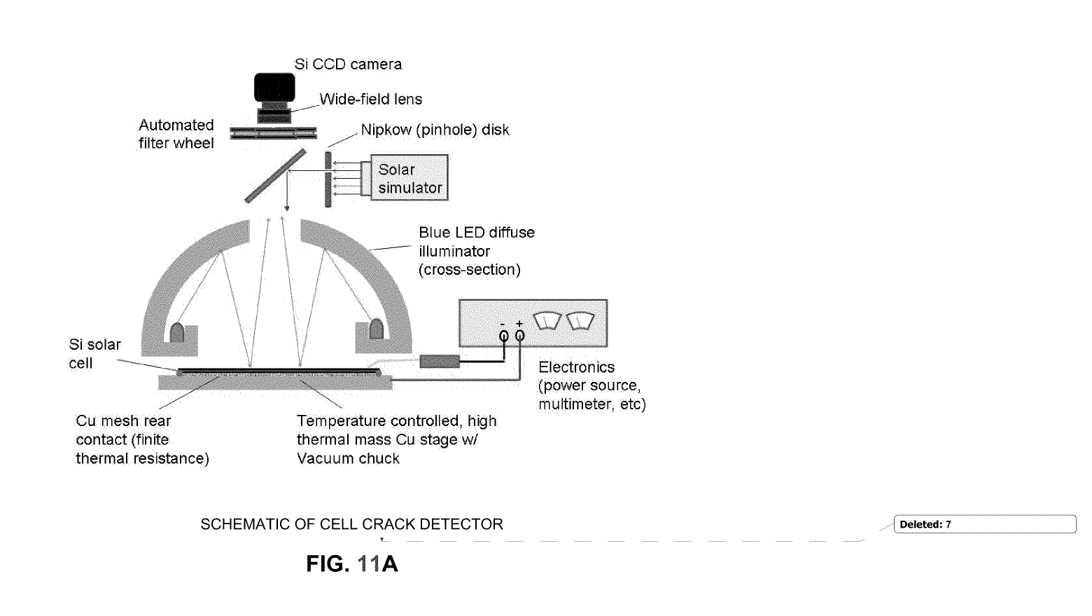

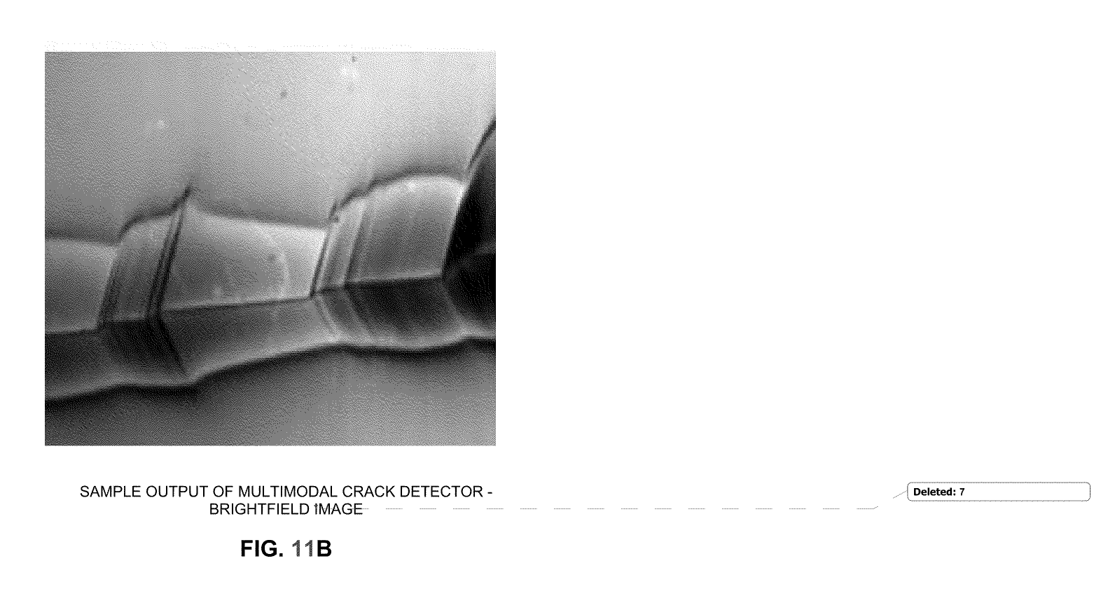

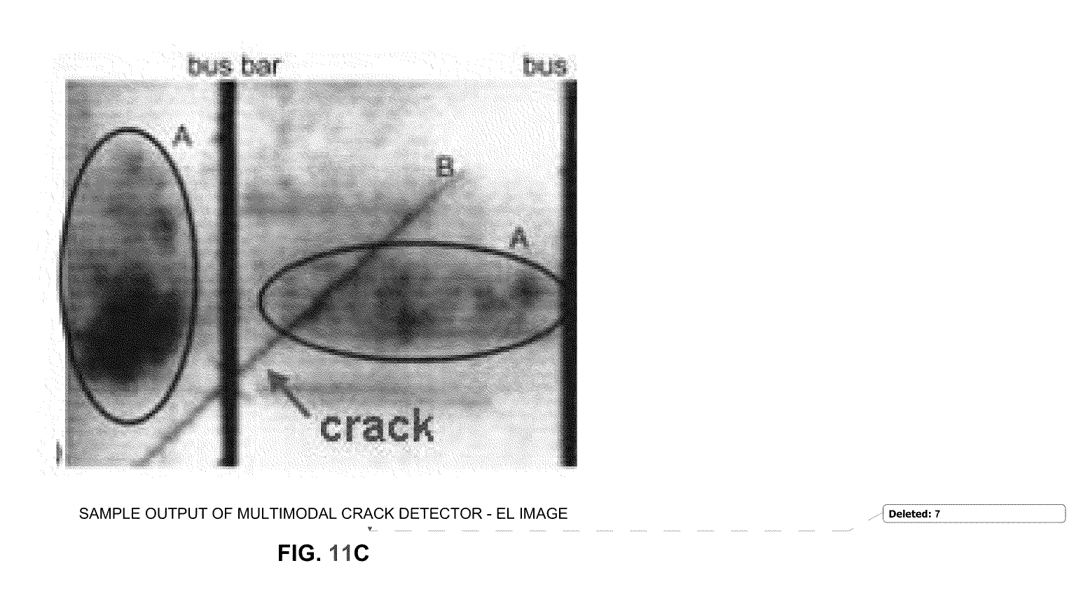

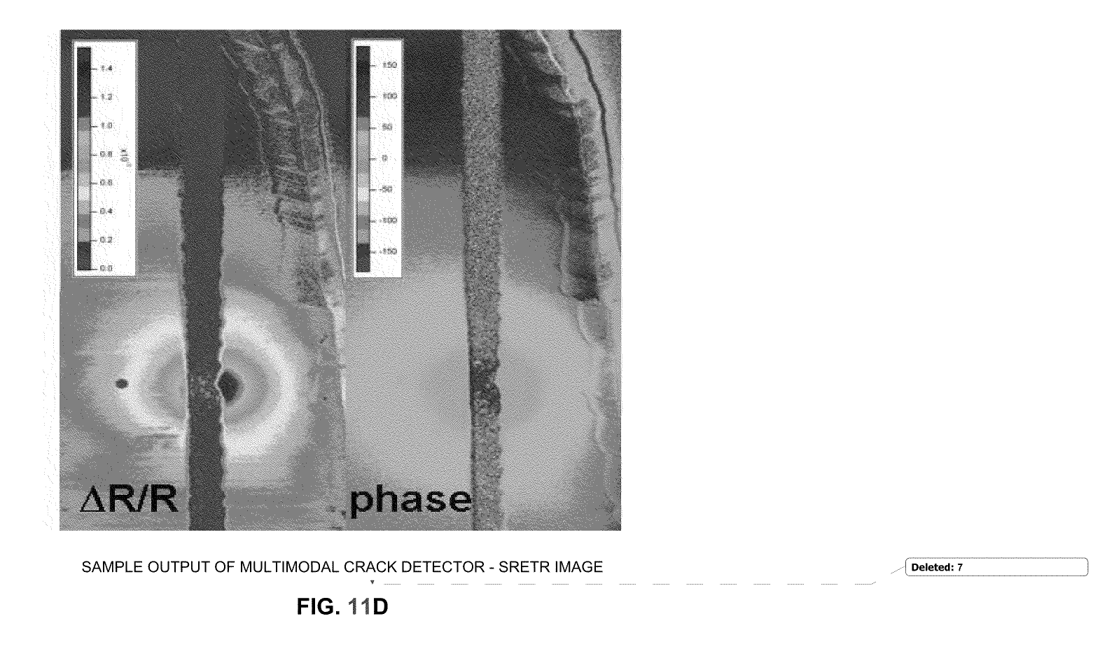

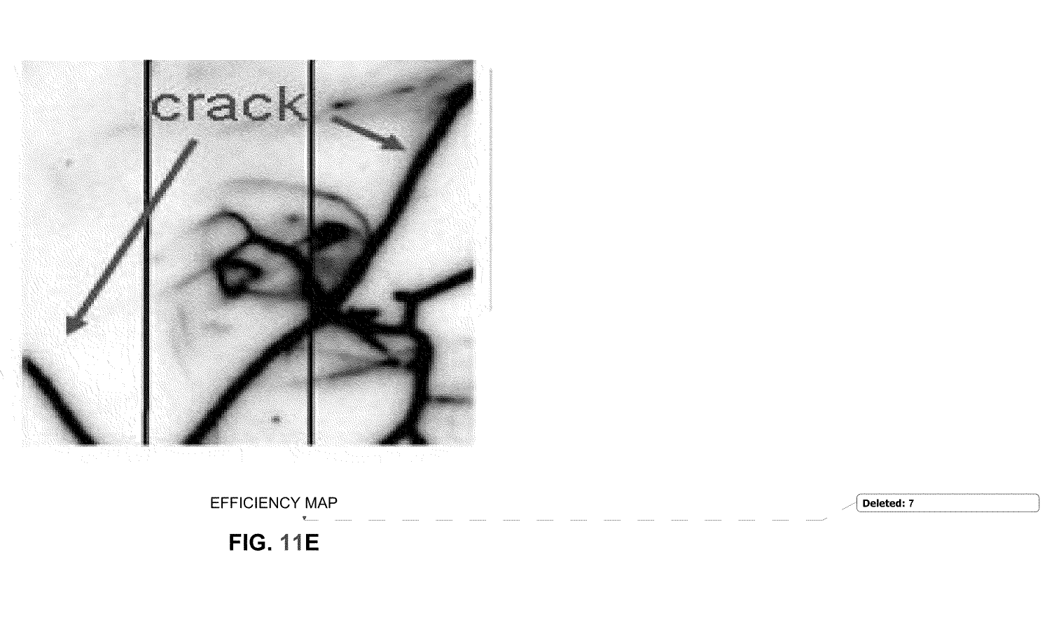

FIG. 11A shows a schematic of a preferred solar cell tester, which uses one or more Si-CCD cameras to perform the measurements. An automated filter wheel in front of the CCD camera enables the user to switch rapidly among the types of measurements. A high pass (>1000 nm) wavelength filter enables imaging of band-to-band electroluminescence (EL) from a forward biased solar cell (note that a standard Si-CCD camera overlaps the band-to-band EL emission range from Si cells); a sample image is shown in FIG. 11B. A low-pass (<880 nm) filter enables imaging of the visible emission from reverse-biased solar cells approaching breakdown, and a bandpass filter at the probe wavelength (470 nm) enables the user to do thermal imaging using the aforementioned stochastic resonance enhanced thermoreflectance (SRETR) technique. A solar simulator, confocal Nipkow disk, and various electronics may be added as needed. The Nipkow disk is removable, but the disk does not interfere with the other imaging modalities. All image modes can utilize the aforementioned stochastic resonance enhancements to achieve maximum resolution, or can be performed in lock-in or standard DC modes if desired.

Diffuse angle illumination can be used to minimize problems due to specular reflection and surface texturing. A specific need of this system is very uniform illumination sources, both for the “sun” in the illuminated testing modes and for the probe wavelength used in thermoreflectance (TR) imaging. Any one of a variety of illumination sources, including dome lights, holographic diffusers, or an LED array, can be used to reach the needed illuminant uniformity over the cell.

### Additional Details on Some of the Specific Imaging Tasks

### Minority Carrier Lifetime Imaging

Minority carrier lifetime (or diffusion length) is one of the most important parameters governing solar cell quality, as it sets the short circuit current and open circuit voltage. However, carrier lifetime may vary widely across a cell, due to electrically active defects, grain boundaries, etc. Of the various existing techniques for mapping the carrier lifetime across a solar cell, the most common is the laser beam induced current (LBIC) method. However, LBIC requires raster scanning across the cell and hence is too slow for a manufacturing environment.

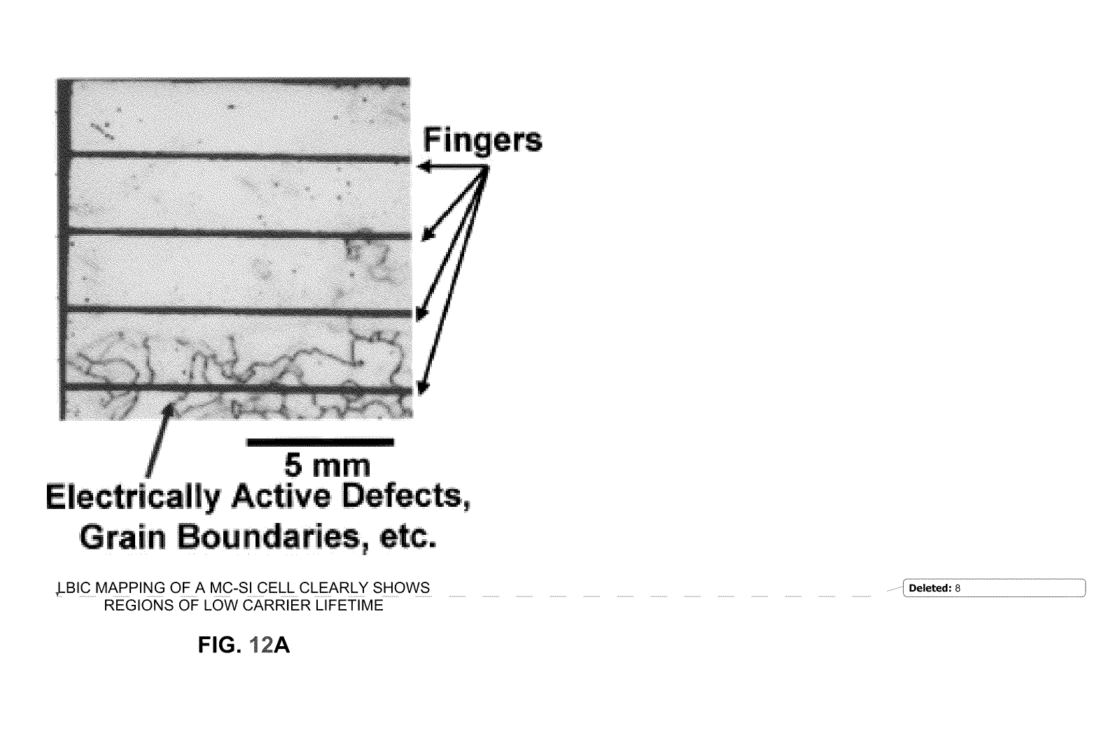

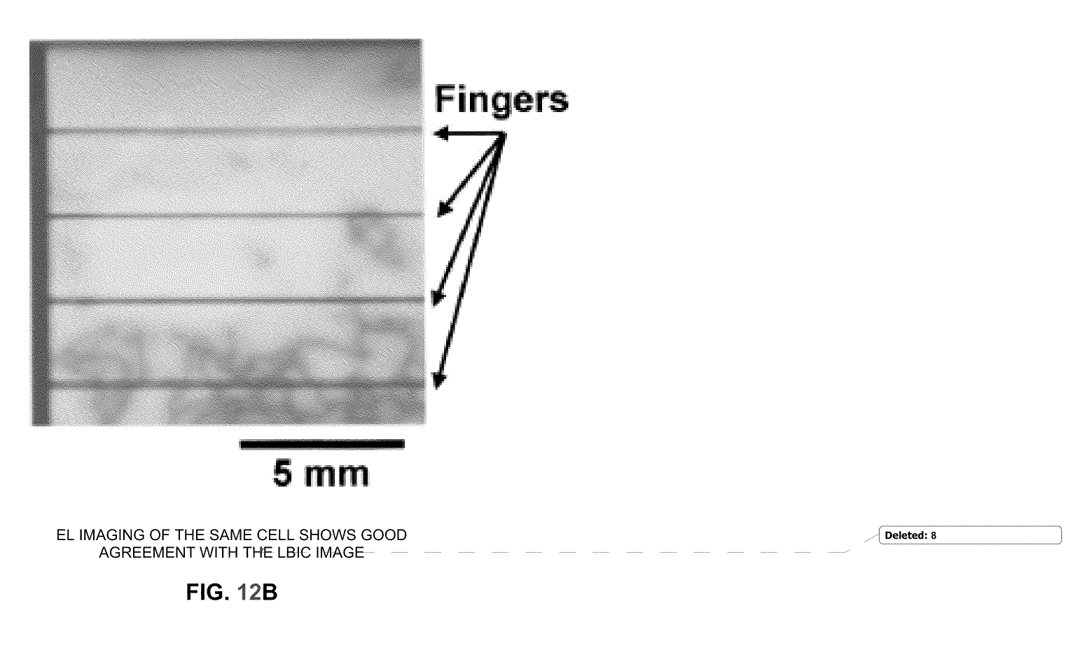

The present invention offers two alternatives for minority carrier lifetime imaging: electroluminescence (EL) imaging and bright-field thermoreflectance imaging (ITR). Electroluminesence (EL) images show dark dendritic regions of reduced emission in regions where the carrier lifetime is diminished due to non-radiative recombination at defects; see FIGS. 12A and 12B. Illuminated lock-in IR thermography (ILIT) has also been demonstrated as a carrier lifetime imaging technique and correlates well with LBIC results.

The electroluminescence (EL) and bright-field thermoreflectance (ITR) imaging modes of the present invention can be used to map the carrier lifetime of solar cells. Both techniques are believed to offer improvements in spatial resolution relative to IR thermography and speed improvements relative to LBIC. Furthermore, cross-correlations between the two sets of images may be useful in distinguishing between various confounding factors (for example, EL images are also affected by variations in local series resistance).

### Series Resistance Mapping

Series resistance is a critical parameter in maximizing the fill factor of a solar cell. However, series resistance can vary widely across even a single solar cell, so techniques for spatially resolved measurements of series resistance of cells are of great interest in order to identify the localized physical defects causing areas of high resistance.

A range of new techniques have been proposed for extracting local IV characteristics of cells using electroluminescence (EL), thermal images, or a combination thereof. These techniques suggest the possibility of quantitatively mapping series resistance across a cell. However, in results reported so far, lack of resolution in the EL or thermal images leads to large uncertainties in the local resistance, much of the work was done on single crystal Si cells, and many of the local series resistance measurements have not been correlated with standard electrical measurements of global series resistance, which ultimately determines fill factor.

A solar cell tester formed in accordance with the present invention can be used for quantitative mapping of the local series resistance of cells by combining the electroluminescence (EL) and thermal (TR) imaging modes. In particular, there are two alternatives which may be used: (1) using the derivative of the EL images (dEL) with applied voltage bias to extract the local IV curves, and (2) combining EL and dark thermal images (RESI) to extract series resistance.

The primary limitation to date on the use of dEL is poor signal-to-noise ratio. Here, the stochastic resonance enhanced (SRE) electroluminescence (EL) measurements of the present invention should be of significant benefit and dEL may become a practical technique for obtaining quantitative, high-resolution series resistance images.

Likewise, the recently proposed RESI technique has been limited by both the coarse electroluminescence (EL) resolution and the poor spatial resolution of conventional IR thermal imaging. Additional series resistance imaging techniques using the illuminated thermal images of the present invention may also become a practical technique for obtaining quantitative, high-resolution series resistance images.

### Detection of Local Breakdown of Pn Junction

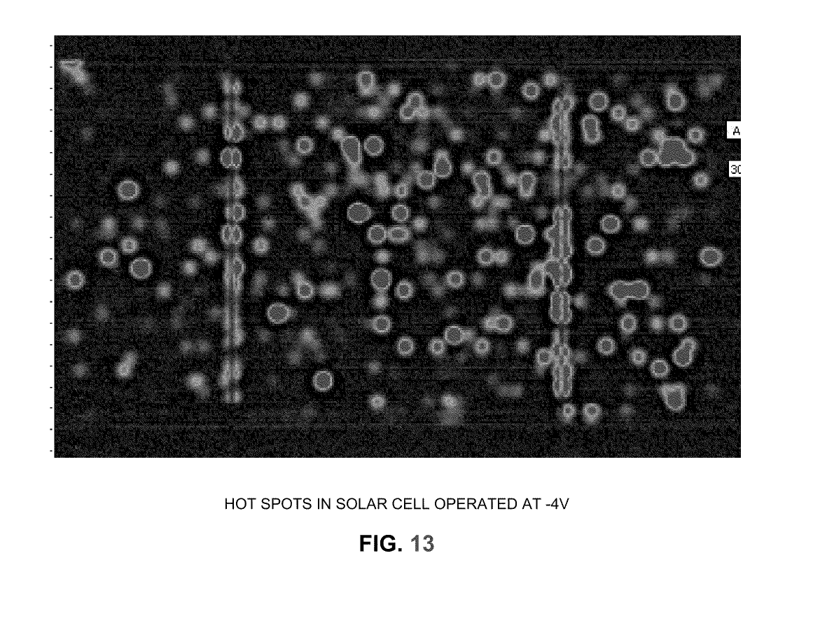

Under standard operating conditions (e.g., when a panel is partially shaded), commercial solar cell panels can reach operating conditions in which a component cell is operated at a reverse bias approaching −10V. In theory, the junction breakdown voltage of a commercial mc-Si solar cell with a base doping on the order of 10¹⁶ cm⁻³ is about −50V; however, it now appears (see FIG. 13) that localized junction breakdown can occur at biases as low as −4V. Under moderate field operating conditions of −10V, hot spots at the junction breakdown sites or shunts can approach several hundreds of degrees centigrade, damaging the solar cell or module.

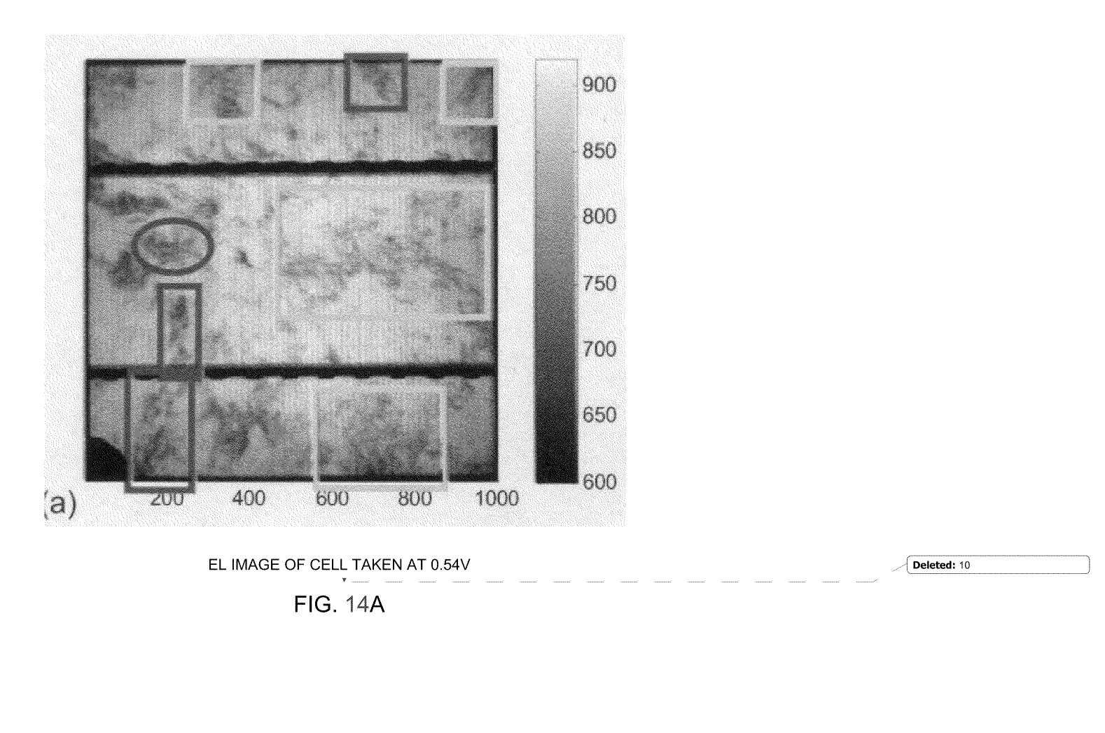

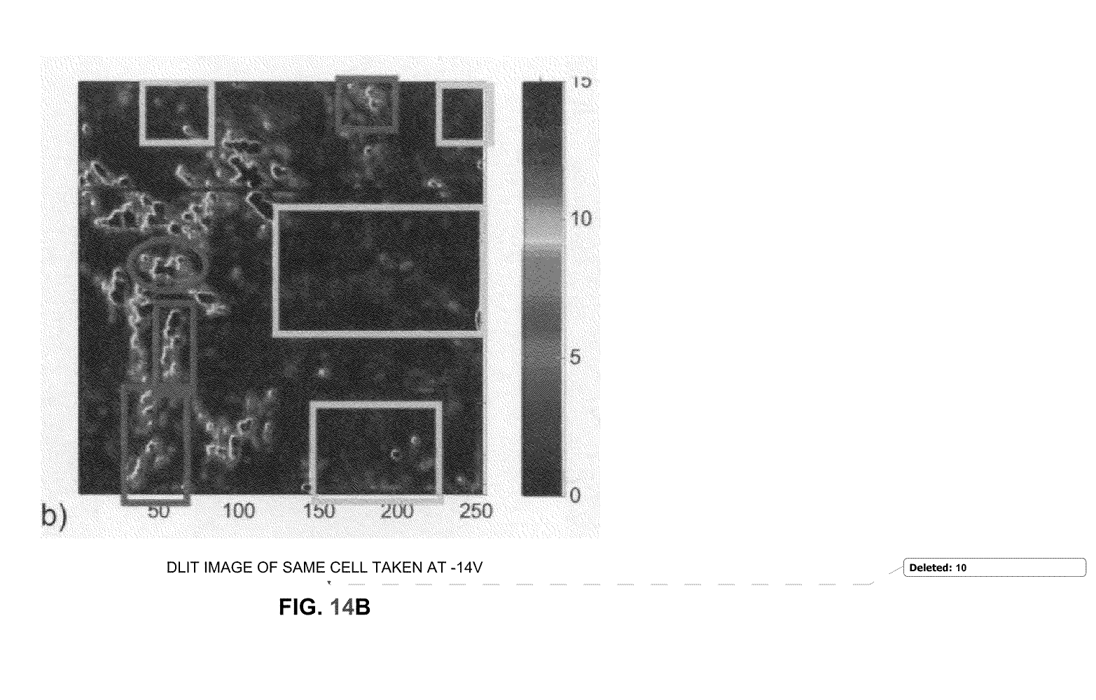

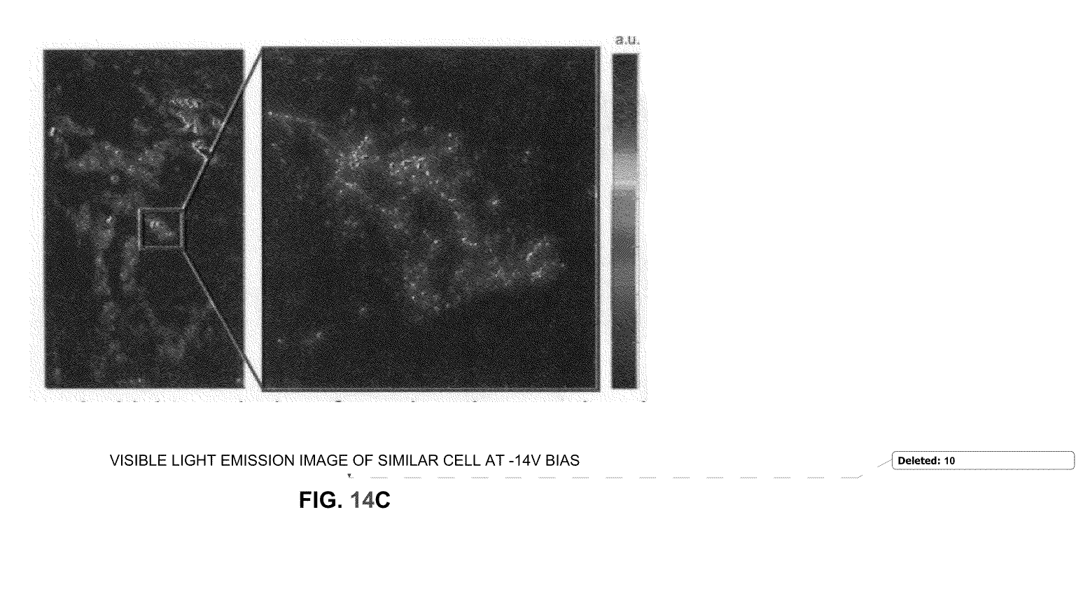

Various of the imaging modes of the novel cell tester, including electroluminescence (EL), visible, and thermal, are useful for spatially resolving regions of early breakdown of the cell junction. FIG. 14A shows an EL image of a forward-biased mc-Si solar cell; the sharp dendritic dark regions in the image are caused by very low carrier density due to recombination at defects. FIG. 14B shows an IR-thermography image of the same cell, operated under reverse bias (−14V) with no illumination (DLIT); hot spots due to local onset of junction breakdown are clearly visible and, in many cases, correlate with the defect regions seen in the EL image. FIG. 14C shows the visible emission from a similar cell, under the same conditions (reverse biased at −14V, no illumination); the emission region correlates with hot spots seen in the corresponding thermal image (not shown).

The cell tester of the present invention can be used to image localized junction breakdown in each of the three modes (EL, thermal, visible). Furthermore, differential results (i.e., variations in the signature with changes in bias conditions) may be used as well. Correlating the defect signatures in each of the three physical measurements (i.e., EL, thermal and visible) enable the extraction of detailed information about the underlying physical mechanism causing each of the spatially localized breakdown regions. For example, localized hot spots from the thermal image that correlate with visible emission in the 880 nm range are indicative of a particular avalanche junction breakdown mechanism.

### Detecting Mechanical Defects, Shunts, and Microcracks

The present invention provides several possible approaches for stochastic resonance enhanced thermoreflectance (SRETR) thermographic detection of cracks, as follows:

(i) Dark, Reverse Bias SRETR. Using the present invention, it has been discovered that there is a dramatic thermoreflectance signature at cracks on solar cells operated under reverse bias (−4V) with no illumination. These relatively large (mm) cracks are easily identifiable in the SRETR phase image in particular, presumably due to thermomechanical expansion at the crack.

(ii) Illuminated, Forward Bias Thermography. Thermographic crack detection relies on a thermal gradient across the defect. Uneven absorption and conversion efficiency in illuminated, forward biased cells may be utilized to provide thermal gradients for crack detection.

(iii) Unevenly Heated/Cooled Cells: There are various methods of lateral surface heating, in which a thermal wave is propagated across the surface of the cell, for crack detection via thermomechanical expansion at cracks or large interface thermal resistances. It is believed that asymmetric electrical contact to the cell creates enough of a lateral thermal variation to visualize cracks using the present invention. Other techniques include spatially nonuniform light absorption or blowing air across the cell.

(iv) Mechanical Vibration. Mechanical vibration of the cell may be used to cause friction heating at the cracks which can then be visualized using the present invention.

Furthermore, the SRE measurements are quite sensitive to mechanical deflection, so the method of the present invention can be used to identify cracks based on mechanical movement at the cracks. In this operating modality, a mechanical wave can be propagated across the cell, resulting in a distinct signature at the cracks in the phase and amplitude reflectance maps. Or, thermomechanical expansion due to heating at nearby shunts or other defects can cause sufficient deflection at a crack; see FIG. 1.

### 2D Efficiency Mapping

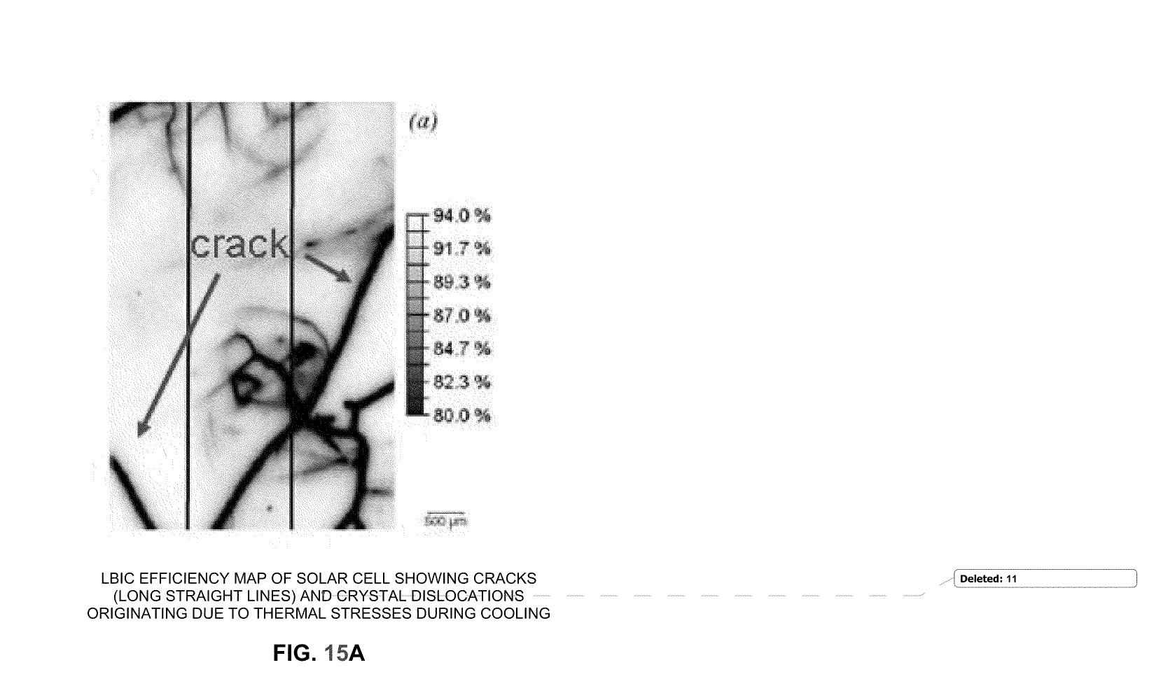

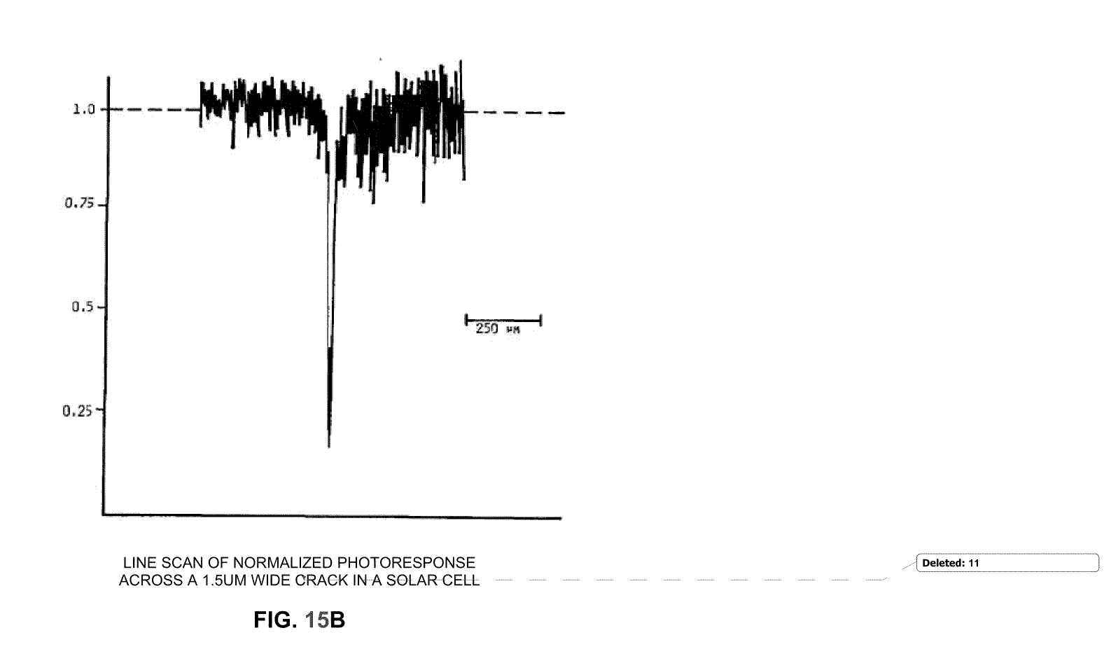

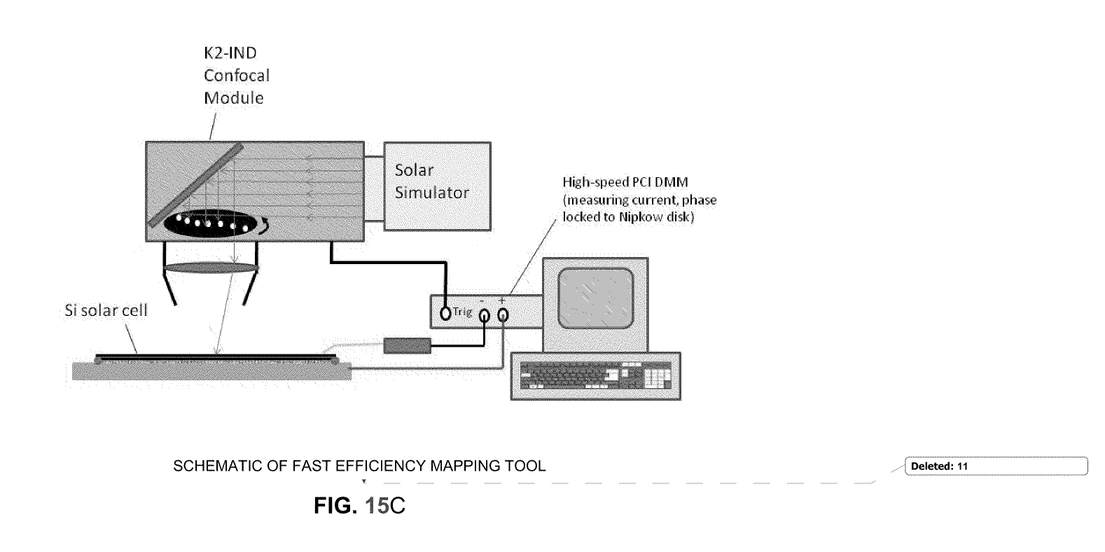

Cracks and other defects in solar cells cause inhomogeneities in current density and optical absorption, resulting to sharp dips in the local photoresponse (or local operating efficiency) at the defects. Hence, efficiency mapping of cells is another powerful technique for detecting cracks and defects; see FIG. 15. The traditional commercially available LBIC efficiency mapping technique is so effective that it is often used as the benchmark against which new defect detection tools are compared. However, existing techniques such as LBIC rely on raster scanning of a focused laser beam across the cell, which is too slow (>10 minutes) to be useful on a process line. Furthermore, narrow linewidth illumination is not representative of the broad spectrum solar illumination of operating solar cells.

In contrast, the present invention provides a powerful new crack detection tool using high speed imaging for efficiency mapping with no raster scanning. FIG. 15C shows a schematic of this tool. The test cell is illuminated by light from a laser or a broad spectrum solar simulation lamp, which first passes through a Nipkow spinning disk. The Nipkow disk, which is essentially a pinhole array, sweeps a single pinpoint of illumination across the entire cell area as it rotates, resulting in fast, single-point illumination of the cell. To map the operating efficiency, the solar cell is biased at standard operating conditions and, as each individual pinpoint on the cell is illuminated, the resulting photocurrent is measured. With fast electronics, a map of the operating efficiency of the cell can be acquired in less than 1 s, with cracks visible as in FIG. 15A.

This tool can be combined with the other imaging modalities; see FIG. 11A.

### Algorithms to Cross-Correlate Data Between Imaging Modalities

Cross-correlation between the imaging modalities can be used to reduce the false-positive rate for detection of cracks, shunts, etc. For example, both cracks and crystal dislocations appear as sharp dark lines in efficiency maps and can be difficult to distinguish (see FIG. 1E). However, the corresponding stochastic resonance enhanced thermoreflectance (SRETR) image is not sensitive to crystal dislocations or grain boundaries, so it could be used to reject efficiency map false crack detection. Thus it will be seen that algorithms can be developed to use the contrasting signatures of each image modality to accurately distinguish the various types of defects present in the solar cell.

### Various Methods of Defect Detection Prior to Applying Electrical Contacts

Some of the methods discussed above require an electrical contact to be made with the solar cells, which is a practical limitation in some situations. However, the present invention can also be used with various non-electrical means of cell stimulation, suitable for wafer stage inspection. Such possible techniques include inductively heated thermography, which could be extended to enable radiatively induced currents for EL imaging or the use of an induction antenna for efficiency mapping. Alternatively, photoluminescence (PL) or other methods of optically stimulating or heating (e.g., through optical absorption) the sample do not require the aforementioned electrical contact.

### Various Extensions of Invention

The present invention can also be applied to the NDE of other types of solar cells in addition to polycrystalline Si, including but not limited to crystalline Si, mc-Si, thin film, Cd—Te, organic, etc.

And the present invention can be applied to the NDE of other test samples besides solar cells, e.g., advanced composites, devices, materials, etc.

### Modifications

It will be appreciated that still further embodiments of the present invention will be apparent to those skilled in the art in view of the present disclosure. It is to be understood that the present invention is by no means limited to the particular constructions herein disclosed and/or shown in the drawings, but also comprises any modifications or equivalents within the scope of the invention.

TABLE 1
Comparison of SRE thermoreflectance imaging and infrared thermal imaging

| | Lock-in IR Thermography | SRE Thermoreflectance |
|---|---|---|
| Pixels, typical | 360 × 240 | 1000 × 1000 |
| Wavelength of sensing | 8-12 μm IR | Visible or convenient |
| | | wavelength |
| Spatial resolution | 10,000 nm | 250 nm |
| Temperature resolution | 10 mK | 10 mK on gold |
| | | 1 mK expected on mc-Si |
| Lenses/fiber optics | Expensive germanium lenses; | Ordinary glass lenses; |
| | no fiber optics | also fiber optic bundles |
| System Cost | $100-300K | ≈$20-40K |
| Speed | Minutes-hours for high thermal | 10-100 s for high thermal |
| | resolution lock-in thermography | resolution |

What is claimed is:

1. A non-destructive evaluation system for evaluating an article such as a test sample, the system comprising:
a silicon-based CCD camera for obtaining a series of images of the article;
first apparatus for receiving the series of images of the article from the silicon-based CCD camera and using a first imaging modality to generate a first data set spatially correlated to the article;
second apparatus for receiving the series of images of the article from the silicon-based CCD camera and using a second imaging modality to generate a second data set spatially correlated to the article; and
processing apparatus for processing at least one of the first and second data sets so as to evaluate at least one physical characteristic of the article.

2. A system according to claim 1 wherein the article comprises a silicon solar cell.

3. A system according to claim 1 wherein the first imaging modality comprises one from the group consisting of: thermoreflectance (TR); electroluminescence (EL); photoluminescence (PL); photoconductivity; mechanical deflection; visible light emission; and standard visible imaging.

4. A system according to claim 1 wherein the first imaging modality includes stochastic resonance enhanced imaging.

5. A system according to claim 3 wherein the second imaging modality comprises one from the group consisting of: thermoreflectance (TR); electroluminescence (EL); photoluminescence (PL); photoconductivity; mechanical deflection; visible light emission; and standard visible imaging.

6. A system according to claim 5 wherein the second imaging modality includes stochastic resonance enhanced imaging.

7. A system according to claim 5 wherein the first and second imaging modalities both include stochastic resonance enhanced imaging.

8. A system according to claim 1 wherein the physical characteristic comprises one from the group consisting of: cracks; inclusions; voids; flaws; shunts; contact resistance; metallization flaws; early breakdown sites; minority carrier lifetime; local IV curves; local operating efficiency; and series resistance.

9. A system according to claim 1 wherein the processing apparatus is adapted to process both the first and second data sets so as to evaluate at least one physical characteristic of the article.

10. A system according to claim 1 wherein the at least one physical characteristic can be unambiguously identified using the first imaging modality.

11. A system according to claim 1 wherein the at least one physical characteristic cannot be unambiguously identified using only one of the first imaging modality and the second imaging modality.

12. A system according to claim 1 wherein the at least one physical characteristic can be unambiguously identified by using both the first imaging modality and the second imaging modality.

13. A system according to claim 1 further comprising:
third apparatus for receiving the series of images of the article from the silicon-based CCD camera and using a third imaging modality to generate a third data set spatially correlated to the article; and
processing apparatus for processing at least one of the first, second and third data sets so as to evaluate at least one physical characteristic of the article.

14. A non-destructive evaluation system for evaluating a solar cell, the system comprising:
a silicon-based CCD camera for obtaining a series of images of the solar cell;
first apparatus for receiving the series of images of the solar cell from the silicon-based CCD camera and using a thermoreflectance (TR) modality to generate a first data set spatially correlated to the solar cell;
second apparatus for receiving the series of images of the solar cell from the silicon-based CCD camera and using a second imaging modality to generate a second data set spatially correlated to the solar cell; and
processing apparatus for processing both the first and second data sets so as to evaluate at least one physical characteristic of the solar cell.

15. A system according to claim 14 wherein the second imaging modality comprises one from the group consisting of: thermoreflectance (TR); electroluminescence (EL); photoluminescence (PL); photoconductivity; mechanical deflection; visible light emission; and standard visible imaging.

16. A system according to claim 14 wherein at least one of the thermoreflectance (TR) imaging modality and the second imaging modality includes stochastic resonance enhanced imaging.

17. A system according to claim 14 wherein the physical characteristic comprises one from the group consisting of: cracks; inclusions; voids; flaws; shunts; contact resistance; metallization flaws; early breakdown sites; minority carrier lifetime; local IV curves; local operating efficiency; and series resistance.

18. A non-destructive evaluation system for evaluating a solar cell, the system comprising:
a silicon-based CCD camera for obtaining a series of images of the solar cell;
apparatus for receiving the series of images of the solar cell from the silicon-based CCD camera and using a stochastic resonance enhanced thermoreflectance (TR) modality to generate a data set spatially correlated to the solar cell; and
processing apparatus for processing the data set so as to evaluate at least one physical characteristic of the solar cell.

19. A method for evaluating an article such as a test sample, the method comprising the steps of:
generating a series of images of the article using a silicon-based CCD camera;
using a first imaging modality to generate a first data set spatially correlated to the article from the series of images generated by the silicon-based CCD camera;
using a second imaging modality to generate a second data set spatially correlated to the article from the series of images generated by the silicon-based CCD camera; and
processing at least one of the first and second data sets so as to evaluate at least one physical characteristic of the article.

20. A method according to claim 19 wherein the article comprises a silicon solar cell.

21. A method according to claim 19 wherein the first imaging modality comprises one from the group consisting of: thermoreflectance (TR); electroluminescence (EL); photoluminescence (PL); photoconductivity; mechanical deflection; visible light emission; and standard visible imaging.

22. A method according to claim 19 wherein the first imaging modality includes stochastic resonance enhanced imaging.

23. A method according to claim 21 wherein the second imaging modality comprises one from the group consisting of: thermoreflectance (TR); electroluminescence (EL); photoluminescence (PL); photoconductivity; mechanical deflection; visible light emission; and standard visible imaging.

24. A method according to claim 23 wherein the second imaging modality includes stochastic resonance enhanced imaging.

25. A method according to claim 23 wherein the first and second imaging modalities both include stochastic resonance enhanced imaging.

26. A method according to claim 19 wherein the physical characteristic comprises one from the group consisting of: cracks; inclusions; voids; flaws; shunts; contact resistance; metallization flaws; early breakdown sites; minority carrier lifetime; local IV curves; local operating efficiency; and series resistance.

27. A method according to claim 19 wherein the processing apparatus is adapted to process both the first and second data sets so as to evaluate at least one physical characteristic of the article.
